(19) United States
(12) Patent Application Publication
(10) Pub. No.: US 2026/0222370 A1
(43) Pub. Date: Jul. 30, 2026

(54) INFORMATION PROCESSING SYSTEM, INFORMATION PROCESSING METHOD, AND NON-TRANSITORY RECORDING MEDIUM

(71) Applicant: Atsuo SHIMADA, Kanagawa (JP)

(72) Inventor: Atsuo SHIMADA, Kanagawa (JP)

(21) Appl. No.: 19/405,465

(22) Filed: Dec. 2, 2025

(30) Foreign Application Priority Data
Jan. 29, 2025 (JP) 2025-012715
Oct. 10, 2025 (JP) 2025-171598

(51) Int. Cl. H04L 51/02; G06F 3/0482

(52) U.S. Cl. CPC H04L 51/02; G06F 3/0482

(57) ABSTRACT

An information processing system includes an information processing apparatus including first circuitry and a communication terminal including second circuitry. The first circuitry is to transmit, to the communication terminal, web content data for displaying a first web page and a second web page and including a script. The second circuitry is to display the first web page based on the web content data, receive an input of a first message from a user via the first web page, and execute the script to transmit a HyperText Transfer Protocol (HTTP) request including the first message to the information processing apparatus. The first circuitry is further to, in response to the HTTP request, identify multiple interactive artificial intelligences (AIs) based on the first message, each AI being to generate a response to the first message, and transmit an HTTP response including information on the multiple interactive AIs to the communication terminal.

### CROSS-REFERENCE TO RELATED APPLICATIONS

This patent application is based on and claims priority pursuant to 35 U.S.C. § 119(a) to Japanese Patent Application Nos. 2025-012715, filed on Jan. 29, 2025 and 2025-171598, filed on Oct. 10, 2025, in the Japan Patent Office, the entire disclosure of which is hereby incorporated by reference herein.

### BACKGROUND

### Technical Field

The present disclosure relates to an information processing system, an information processing method, and a non-transitory recording medium.

### Related Art

Artificial intelligence (AI) has been devised that automatically generates a response to a message such as a question from a user and outputs the response to interact with the user.

For example, for each of multiple bots, a bot capability catalog representing the capabilities of the bot in natural language is collated with a user service prompt represented in natural language. Then, based on the collation result, one or more bots are designated.

### SUMMARY

The present disclosure described herein provides an information processing system including an information processing apparatus including first circuitry and a communication terminal including second circuitry. The first circuitry is to transmit, to the communication terminal, web content data for displaying a first web page and a second web page and including a script. The second circuitry is to display, on a display, the first web page based on the web content data, receive an input of a first message from a user via the first web page, and execute the script to transmit a HyperText Transfer Protocol (HTTP) request including the first message to the information processing apparatus. The first circuitry is further to, in response to the HTTP request, identify a plurality of interactive artificial intelligences (AIs) based on the first message, each AI being to generate a response to the first message, and transmit an HTTP response including information on the plurality of interactive AIs to the communication terminal. The second circuitry is further to execute the script to display, on the display, the second web page including the responses to the first message from the plurality of interactive AIs based on the HTTP response to allow the user to select one or more of the plurality of interactive Ais, and in a case that one interactive AI is selected from among the plurality of interactive AIs, display, on the display, a dialog screen for receiving input of a second message to the selected interactive AI.

The present disclosure described herein provides an information processing method performed by an information processing apparatus communicably connected with a communication terminal, including transmitting, to the communication terminal, web content data for displaying a first web page and a second web page and including a script, receiving a HyperText Transfer Protocol (HTTP) request transmitted from the communication terminal in execution of the script, the HTTP request including a first message being input by a user on the first web page displayed on the communication terminal based on the web content data, identify a plurality of interactive artificial intelligences (AIs) based on the first message, each AI being to generate a response to the first message, transmit an HTTP response including information on the plurality of interactive AIs to the communication terminal, the script further causing the communication terminal to display the second web page including the responses to the first message from the plurality of interactive AIs based on the HTTP response to allow the user to select one or more of the plurality of interactive AIs, and in a case that one interactive AI is selected from among the plurality of interactive AIs, causing the communication terminal to display a dialog screen for receiving input of a second message to the selected interactive AI.

The present disclosure described herein provides a non-transitory recording medium storing a plurality of program codes which, when executed by one or more processors on an information processing, causes the one or more processors to perform a method including transmitting, to the communication terminal, web content data for displaying a first web page and a second web page and including a script, receiving a HyperText Transfer Protocol (HTTP) request transmitted from the communication terminal in execution of the script, the HTTP request including a first message being input by a user on the first web page displayed on the communication terminal based on the web content data, identify a plurality of interactive artificial intelligences (AIs) based on the first message, each AI being to generate a response to the first message, transmit an HTTP response including information on the plurality of interactive AIs to the communication terminal, the script further causing the communication terminal to display the second web page including the responses to the first message from the plurality of interactive AIs based on the HTTP response to allow the user to select one or more of the plurality of interactive AIs, and in a case that one interactive AI is selected from among the plurality of interactive AIs, causing the communication terminal to display a dialog screen for receiving input of a second message to the selected interactive AI.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system according to a first embodiment;

FIG. 2 is a block diagram illustrating a hardware configuration of an information processing apparatus according to the first embodiment;

FIG. 3 is a block diagram illustrating a functional configuration of an information processing system according to the first embodiment;

FIG. 4 is a sequence diagram illustrating a process of interaction between a user and an agent according to the first embodiment;

FIG. 5 is a diagram illustrating a dialog screen displayed at the start of interaction;

FIG. 6 is a diagram illustrating a user information database (DB);

FIG. 7 is a diagram illustrating a history information DB;

FIG. 8 is a diagram illustrating a first example of a dialog screen displayed based on an identification result of candidate agents;

FIG. 9 is a diagram illustrating a display example of an adopted response;

FIG. 10 is a diagram illustrating a dialog screen based on an identification result that includes only one candidate agent;

FIG. 11 is a sequence diagram illustrating a process performed by an agent for generating a response to a subject message;

FIG. 12 is a diagram illustrating a first example of a dialog screen displayed based on an identification result of candidate agents identified in the second or subsequent time according to the first embodiment;

FIG. 13 is a diagram illustrating a second example of a dialog screen displayed based on an identification result of candidate agents identified in the second or subsequent time according to the first embodiment;

FIG. 14 is a diagram illustrating a third example of a dialog screen displayed based on an identification result of candidate agents identified in the second or subsequent time according to the first embodiment;

FIG. 15 is a sequence diagram illustrating a process of interaction between a user and an agent according to a second embodiment;

FIG. 16 is a sequence diagram illustrating a process of interaction between a user and an agent according to a third embodiment;

FIG. 17 is a sequence diagram illustrating a process of the second and subsequent interactions according to a fourth embodiment;

FIG. 18 is a diagram illustrating a dialog screen displayed when an adopted agent is determined not be adequate according to the fourth embodiment;

FIG. 19 is a diagram illustrating a dialog screen on which a second or subsequent response is presented according to a modification;

FIG. 20 is a block diagram illustrating a functional configuration of a communication terminal according to a fifth embodiment;

FIG. 21 is a sequence diagram illustrating a process related to screen transition according to the fifth embodiment;

FIG. 22 is a diagram illustrating a dialog screen as displayed after a message is input;

FIG. 23 is a block diagram illustrating a functional configuration of a communication terminal that has the functions of an information processing apparatus; and

FIG. 24 is a diagram illustrating a configuration of an information processing system according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

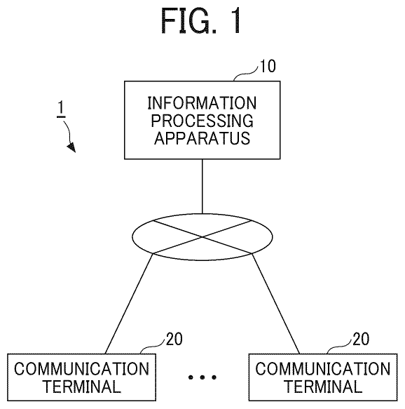

Embodiments of the present disclosure are described below with reference to the drawings. FIG. 1 is a diagram illustrating a configuration of an information processing system 1 according to a first embodiment. In FIG. 1, one or more communication terminals 20 are connected to an information processing apparatus 10 via a network such as a local area network (LAN) or the Internet.

The information processing apparatus 10 is implemented by one or more computers that function as multiple types of interactive artificial intelligence (AI), which is an AI system designed for a two-way communication with a user. The interactive AI is a personified virtual entity that appears to the user as a conversational partner. In the interaction with the interactive AI, which is the conversation partner, in response to a message input by the user, the interactive AI outputs a response. Specifically, the interactive AI receives the message input by the user from a communication terminal 20. The interactive AI searches for document data having a relatively high similarity to the message from a collection of document data registered in advance in the information processing apparatus 10. The interactive AI controls generation of a response to the message based on the searched document data, and outputs the response to the communication terminal 20. The message input by the user may be a question, an instruction, a request, or any other input information that requires a response. The response is text that includes information corresponding to the message. Alternatively, the response may be output by voice. For simplicity, the interactive AI is referred to as an “agent” in the present embodiment. Alternatively, the interactive AI may be referred to as an AI agent, a digital clone, a personalized AI, an AI assistant, an auto-response AI, a conversational partner, an AI chatbot, a companion, a concierge, or a virtual interactive interface. The agent may be a virtual human displayed on the screen of the communication terminal 20 as a conversational partner, for example, in the form of a three-dimensional (3D) avatar imitating a person.

In the present embodiment, multiple types of agents are distinguished from one another based on differences in data sources referred to when generating the response to the message from the user. In other words, each agent is associated with a different data source. The data source refers to a collection of document data. For example, each data source is a collection of document data related to a field different from those of the other data sources. Each data source may include image data. For the same message, each agent searches for document data or image data related to the message from a data source that is different from those for the other agents. Since the response corresponding to the message is generated based on the searched document data or image data, each agent generates a different response to the same message.

The information processing apparatus 10 identifies an agent suitable for generating a response to the message from the user as a response generation source (i.e., a conversational partner) from among the multiple types of agents. In addition, when it is determined that the agent suitable for generating a response to the message from the user changes as the interaction progresses, the information processing apparatus 10 can automatically switch the agent as the conversational partner.

The communication terminal 20 is an apparatus that operates as a user interface of the information processing system 1. For example, the communication terminal 20 may be implemented by a personal computer (PC), a smartphone, or a tablet terminal. The communication terminal 20 receives input of a message from the user and transmits the message to the information processing apparatus 10. The communication terminal 20 also receives a response generated in response to the message from the information processing apparatus 10 and displays the response. The communication terminal 20 may output the received information, for example, through a projector.

In the present embodiment, it is assumed that the information processing system 1 is operated in a certain company, which may be referred to as a “company X” in the following description. The user who can access the information processing apparatus 10 is a person belonging to the company X, such as an employee of the company X. The service provided by the information processing apparatus 10 may be open to the public as a cloud service.

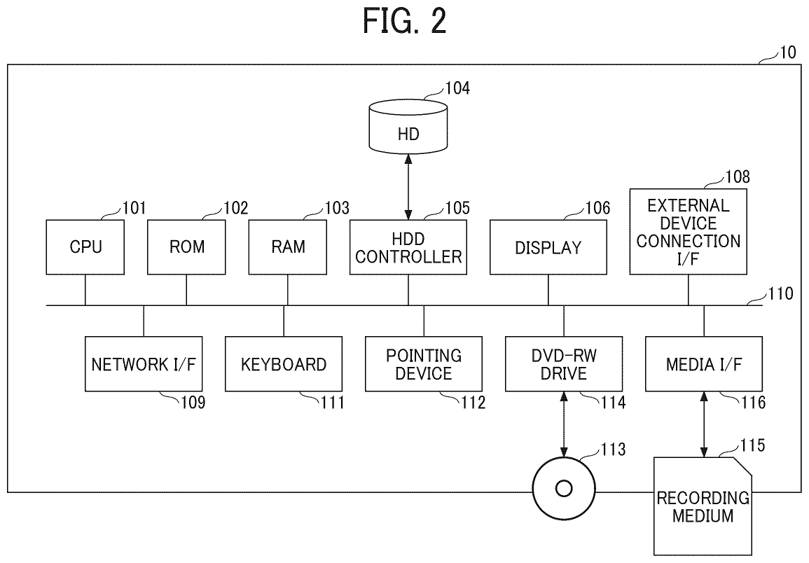

FIG. 2 is a block diagram illustrating a hardware configuration of the information processing apparatus 10 according to the first embodiment. The information processing apparatus 10 is implemented by a computer, and as illustrated in FIG. 2, includes a central processing unit (CPU) 101, a read-only memory (ROM) 102, a random-access memory (RAM) 103, a hard disk (HD) 104, a hard disk drive (HDD) controller 105, a display 106, an external device connection interface (I/F) 108, a network I/F 109, a data bus 110, a keyboard 111, a pointing device 112, a digital versatile disk-rewritable (DVD-RW) drive 114, and a media I/F 116.

The CPU 101 controls the overall operation of the information processing apparatus 10. The ROM 102 stores a program such as an initial program loader (IPL) used for booting the CPU 101. The RAM 103 is used as a work area for the CPU 101. The HD 104 stores various data such as a program. The HDD controller 105 controls the reading of various data from, or the writing of various data to, the HD 104 under the control of the CPU 101. The display 106 displays various types of information, such as a cursor, a menu, a window, text, or an image. The external device connection I/F 108, which may be implemented by an interface circuit, is an interface for connection with various external devices. Examples of the external devices in this case include, but are not limited to, a universal serial bus (USB) memory and a printer. The network I/F 109, which may be implemented by an interface circuit, is an interface for data communication through a communication network. The data bus 110 is, for example, an address bus or a data bus, which electrically connects the components or elements such as the CPU 101.

The keyboard 111 is an example of an input device provided with multiple keys used for inputting characters, numerical values, and various instructions. The pointing device 112 is an example of an input device that allows selection or execution of various instructions, selection of a processing target, and movement of a cursor. The DVD-RW drive 114 controls the reading of various data from, or the writing of various data to, a DVD-RW 113, which is an example of a removable recording medium. The removable recording medium is not limited to a DVD-RW and may be, for example, a digital versatile disc recordable (DVD-R). The media I/F 116 controls the reading of data from, or the writing (storing) of data to (in), a recording medium 115 such as a flash memory.

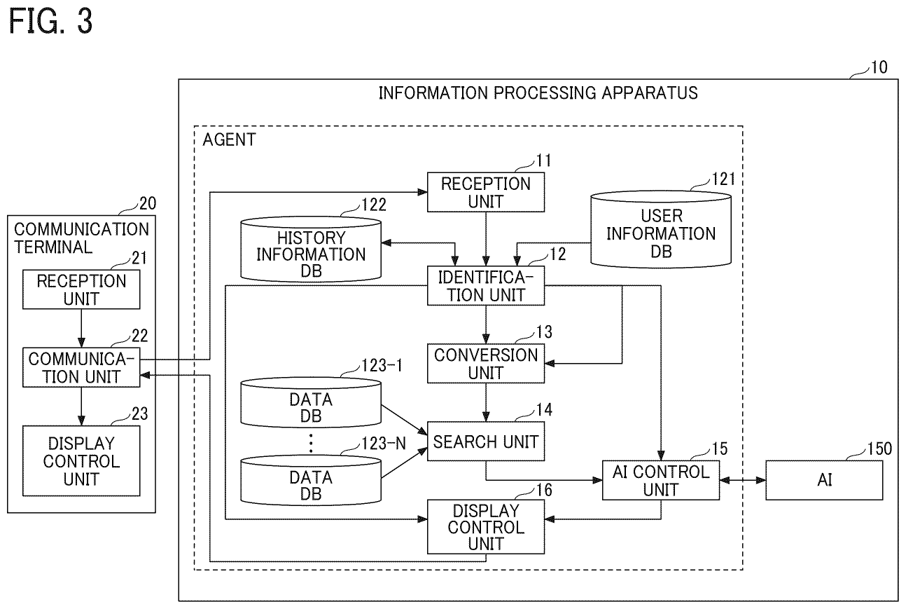

FIG. 3 is a block diagram illustrating a functional configuration of the information processing system 1 according to the first embodiment. In FIG. 3, the information processing apparatus 10 includes AI 150 and an agent.

The AI 150 is a machine-learning model (for example, a neural network), which has been trained to generate text in response to input text. The text being generated may be referred to as a “response,” whereas the input text may be referred to as a “prompt” in the following description. The AI 150 may be trained so as to output a response including, for example, an image or a file. For example, the AI 150 generates, as a response to the prompt, text having the highest occurrence probability based on the training result. The AI 150 may be, for example, a generative AI using a large-scale language model (LLM). The LLM is a machine learning model that has learned natural language processing using a large amount of text data. The LLM is used in many natural language processing (NLP) tasks, such as generation of a response to a specific question, automatic generation of a sentence, summarization of text, translation, and emotion analysis. Further, the LLM may be used in various fields such as education, entertainment, customer service, and product development. In the present embodiment, the prompt is text including the message input by the user. The AI 150 may be a machine-learning model other than the LLM. The AI 150 does not have to be operated on the information processing apparatus 10. For example, the AI 150 may be a generative AI that is open to the public, such as the one available on the Internet.

In the present disclosure, the machine learning is a technique that enables a computer to acquire human-like learning ability. The machine learning refers to a technology in which a computer autonomously generates an algorithm to be used for determination such as data identification from training data loaded in advance and applies the generated algorithm to new data to make a prediction. Any suitable learning method may be applied to the machine learning. For example, any one of supervised learning, unsupervised learning, semi-supervised learning, reinforcement learning, and deep learning may be applied to the machine learning.

The agent is an example of the interactive AI as described above. The agent is a set of functional units, which receives a message from the user and generates a response to the message using, for example, Retrieval Augmented Generation (RAG). Specifically, the agent includes, as the functional units, a reception unit 11, an identification unit 12, a conversion unit 13, a search unit 14, an AI control unit 15, and a display control unit 16. These functional units provide functions implemented by the CPU 101 executing instructions included in one or more programs installed in the information processing apparatus 10. The agent uses a user information database (DB) 121, a history information DB 122, and multiple data DBs 123-1 to 123-N. These DBs may be each implemented by, for example, the HD 104 or a storage device that can be connected to the information processing apparatus 10 via a network.

In the present embodiment, the information processing apparatus 10 functions as multiple types of agents, but the substance of the program that functions as each agent is common among the agents. As described above, the agents are distinguished from one another based on differences in data sources referred to when generating a response.

The reception unit 11 receives input from the user. For example, the reception unit 11 receives a message input by the user. More specifically, the input by the user is performed on the communication terminal 20. The reception unit 11 thus receives information corresponding to the input, which is received by the communication terminal 20, from the communication terminal 20.

The identification unit 12 identifies, based on the content of the message received by the reception unit 11, one or more specific agents, each of which is caused to generate a response to the message. The identified specific agents may be referred to as “candidate agents” in the following description. In other words, the identification unit 12 identifies one or more agents that respond to the message input by the user. The identification unit 12 refers to the history information DB 122 and the user information DB 121 to identify candidate agents. When multiple agents are identified as candidate agents, each of the candidate agents may generate a response to the message. The user designates a response to be adopted. In the following description, the response adopted by the user is referred to as an “adopted response,” and the agent that has generated the adopted response is referred to as an “adopted agent.” In the present embodiment, the identification unit 12 identifies one or more candidate agents based on the interaction history between the user and each agent in the past. However, the way for identifying a candidate agent is not limited thereto. For example, a description describing the role and type of agent is prepared for each agent, and the message input by the user and the descriptions of all agents are transmitted to the AI 150. Then, a prompt may be transmitted to the AI 150 so that candidate agents are identified. In this way, the identification unit 12 may transmit a prompt to the AI 150 and identify candidate agents based on a response from the AI 150 to the prompt.

The history information DB 122 stores messages previously received, information for identifying the agents that have responded to the messages, and attribute information of users who have input the messages, in association with one another.

The identification unit 12 identifies one or more candidate agents for a first message, which is the message received by the reception unit 11, based on the relevance between the first message and each message stored in the history information DB 122. In the present embodiment, the similarity between the messages is an example of the relevance between the messages. The identification unit 12 further identifies one or more candidate agents for the first message based on the similarity between the attribute information of the user associated with the first message and the attribute information stored in the history information DB 122. The attribute information of the user associated with the first message may be acquired from the user information DB 121.

The user information DB 121 stores attribute information for each user of the information processing system 1.

When the reception unit 11 receives a message, the conversion unit 13 converts the message into a vector that represents the meaning of the message by a multi-dimensional numerical value. This vector may be referred to as a “semantic vector” in the following description. The semantic vector may be generated using a natural language processing model, such as Bidirectional Encoder Representations from Transformers (BERT). The semantic vector generated by converting the message may be referred to as a “message vector” in the following description.

The search unit 14 uses the message vector generated by the conversion unit 13 to extract, from among pieces of document data stored in the data DB 123 corresponding to the candidate agents, a subset of document data having a relatively high relevance to the message. The data DB 123 to be searched by the search unit 14, which is a database from which the document data is acquired, differs depending on the agent.

Each data DB 123 stores document data related to various business operations of the company X in advance. The collection of document data stored in each data DB 123 differs. This is because the document data required differs depending on the role of the agent. Accordingly, the data DB 123 may be provided for each agent. Two or more agents may use a part of or all of the same data DB 123. The document data may be registered in the data DB 123 in a batch, or uploaded to the data DB 123 at a timing that the user desires. The data DB 123 stores, for each piece of document data stored in the data DB 123, the document data and a semantic vector for each chunk of the document data. The chunk of the document data refers to a part of the document data obtained by dividing the document data in a predetermined unit. The unit of dividing the document data may be defined by the number of characters, the number of sentences, or a semantic unit (for example, a paragraph). The document data may be divided in units and stored in advance. The semantic vector of each chunk may be referred to as a “chunk vector” in the following description. The search unit 14 calculates, for each piece of document data in the data DB 123 to be searched, the degree of similarity between the message vector and the chunk vector of each chunk associated with the document data. The search unit 14 further identifies a chunk associated with a chunk vector having the highest degree of similarity to the document data, as a “similar chunk.” The search unit 14 compares the degree of similarity of the similar chunks for each piece of document data and extracts the top M similar chunks having the highest degree of similarity. As a result, M pieces of document data are extracted. The degree of similarity between vectors may be evaluated using cosine similarity or another index. The search unit 14 includes, in the search result, information including the top M similar chunks, an identifier (ID) stored in the data DB 123 corresponding to each similar chunk, and an ID stored in the data DB 123 corresponding to the document data to which each similar chunk belongs, and a file name. In the following description, the information is referred to as “related document information,” the ID corresponding to the similar chunk is referred to as a “chunk ID,” the ID corresponding to the document data is referred to as a “document ID,” and the file name is referred to as a “document name.” The data DB 123 may be managed based on a folder, a database, or any other management unit of document data.

The AI control unit 15 transmits a prompt to the AI 150 as an instruction to generate a response. The prompt includes the message received by the reception unit 11 and a collection of similar chunks associated with the search result provided by the search unit 14. The AI control unit 15 receives the response generated by the AI 150 from the AI 150.

The display control unit 16 controls to display the responses generated by one or more candidate agents identified by the identification unit 12. The display control unit 16 also controls to display, on the communication terminal 20, the candidate agents corresponding to the responses so as to be selectable by the user. Displaying, on the communication terminal 20, the candidate agents corresponding to the responses so as to be selectable by the user includes displaying the responses on the communication terminal 20 in a selectable manner so that the candidate agent that has generated the response can be selected by the user selecting the response itself. Further, when one candidate agent is designated from among the candidate agents displayed in a selectable manner, the display control unit 16 controls to display a display screen for receiving input of a message to the selected candidate agent. The display screen is a dialog screen 510, which will be described later. Specifically, the display control unit 16 transmits, to the communication terminal 20, display data to be displayed as the display screen on the communication terminal 20.

The communication terminal 20 includes a reception unit 21, a communication unit 22, and a display control unit 23. These functional units provide functions implemented by the CPU of the communication terminal 20 executing instructions included in one or more programs installed in the communication terminal 20.

The reception unit 21 receives operations to the communication terminal 20 performed by the user.

The communication unit 22 controls communication with the information processing apparatus 10.

The display control unit 23 controls to display screens such as the dialog screen 510 using a browser, based on information received from the information processing apparatus 10 such as display data.

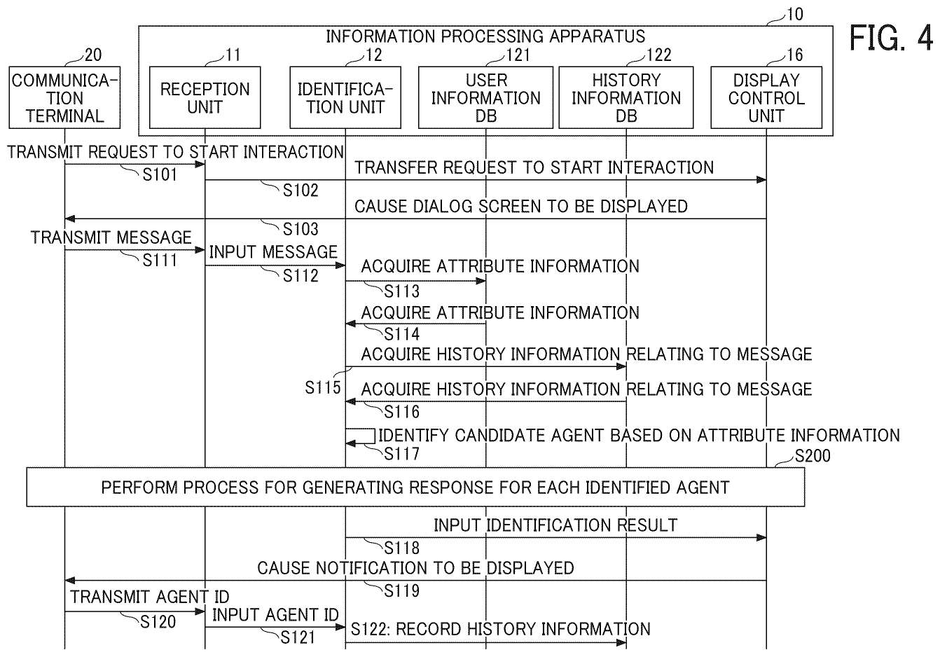

The processes performed by the information processing system 1 are described below. FIG. 4 is a sequence diagram illustrating a process of interaction between the user and the agent according to the first embodiment. At the start of the process in FIG. 4, it is assumed that the user of the communication terminal 20, who is referred to as a “subject user,” has logged in the information processing apparatus 10 after being authenticated by the information processing apparatus 10. In other words, the user ID of the subject user is stored in, for example, the RAM 103 as the user ID of the login user.

When the subject user inputs an instruction to start interaction to the communication terminal 20, in step S101, the communication terminal 20 transmits a request to start interaction to the information processing apparatus 10. In step S102, the reception unit 11 of the information processing apparatus 10 notifies the display control unit 16 of the request to start interaction. In response to the request to start interaction, in step S103, the display control unit 16 causes the communication terminal 20 to display a dialog screen, which is a screen for receiving input of a message from the user and performing interaction between the user and the agent. Specifically, the display control unit 16 generates display data to be displayed as the dialog screen, and transmits the display data to the communication terminal 20 to cause the dialog screen to be displayed.

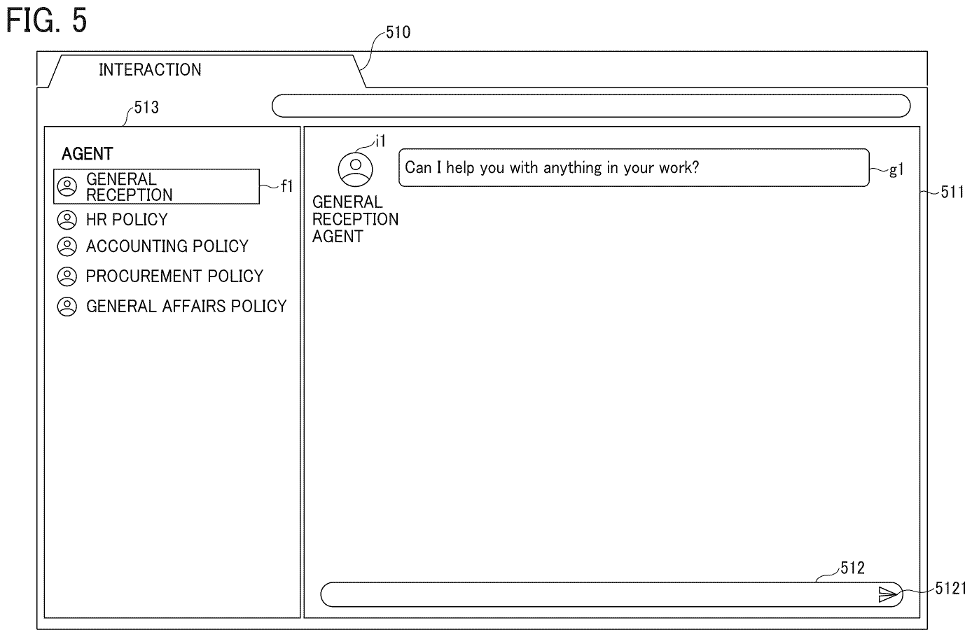

FIG. 5 is a diagram illustrating the dialog screen 510 displayed at the start of interaction. The dialog screen 510 illustrated in FIG. 5 includes an interaction display area 511, a message input area 512, and an agent list display area 513. The interaction display area 511 is an area in which the contents of the interaction between the agent and the user are displayed. At the initial state, in the interaction display area 511, a greeting sentence g1 is displayed, which indicates “Can I help you with anything in your work?” to prompt the user to input a message. An icon i1 representing the agent is displayed on the left of the greeting sentence g1. In the dialog screen 510 at the start of the interaction, the adopted agent is not identified. The greeting sentence g1 initially displayed is assumed to be a greeting sentence from an agent serving as a “general reception agent.” The general reception agent interacts with the user until the adopted agent is identified.

The message input area 512 is an area for receiving input of a message from the user, and includes a send icon 5121. The agent list display area 513 is an area in which the names of all of the multiple types of agents are displayed in the form of a list. The names of agents may be referred to as “agent names” in the following description. When one agent is designated from among the multiple agents displayed in the agent list display area 513, the display control unit 16 may switch the screen to a dialog screen, which allows the user to interact with the designated agent. In FIG. 5, an example is illustrated, in which agents are defined for each type of policies in the company X, such as a “human resources (HR) policy,” an “accounting policy,” a “procurement policy,” and a “general affairs policy,” in addition to the “general reception.” The “HR policy” is a collection of document data describing, for example, a payment standard of allowances, handling of a working time and a travel time during a business trip, and a special rule when traveling abroad. The “accounting policy” is a collection of document data describing, for example, a settlement method of travel expenses, handling of receipts, and a calculation method of exchange rates. The “procurement policy” is a collection of document data describing, for example, a payment procedure when obtaining a passport and an approval flow of purchase. The “general affairs policy” is a collection of document data describing, for example, the operation and management of the business establishment, rules for using a company car, and the reaction and safety management in an emergency. Each agent corresponding to a specific one of these policies interacts with the user as an expert regarding the collection of document data corresponding to each of the policies including the “HR policy,” the “accounting policy,” the “procurement policy,” and the “general affairs policy.” In the agent list display area 513, the agent that is currently the conversational partner is indicated by a frame line f1. In FIG. 5, since the general reception agent is the conversational partner, the “general reception” is surrounded by the frame line f1.

When the user inputs a message to the message input area 512 and clicks the send icon 5121, in step S111 of FIG. 4, the communication terminal 20 transmits the message, which may be referred to as a “subject message” in the following description, to the information processing apparatus 10.

In step S112, in response to receiving the subject message, the reception unit 11 inputs the subject message to the identification unit 12. The identification unit 12 performs the processes of steps S113 to S117 to identify the candidate agents based on the subject message.

In steps S113 and S114, the identification unit 12 acquires the attribute information corresponding to the user ID of the subject user from the user information DB 121.

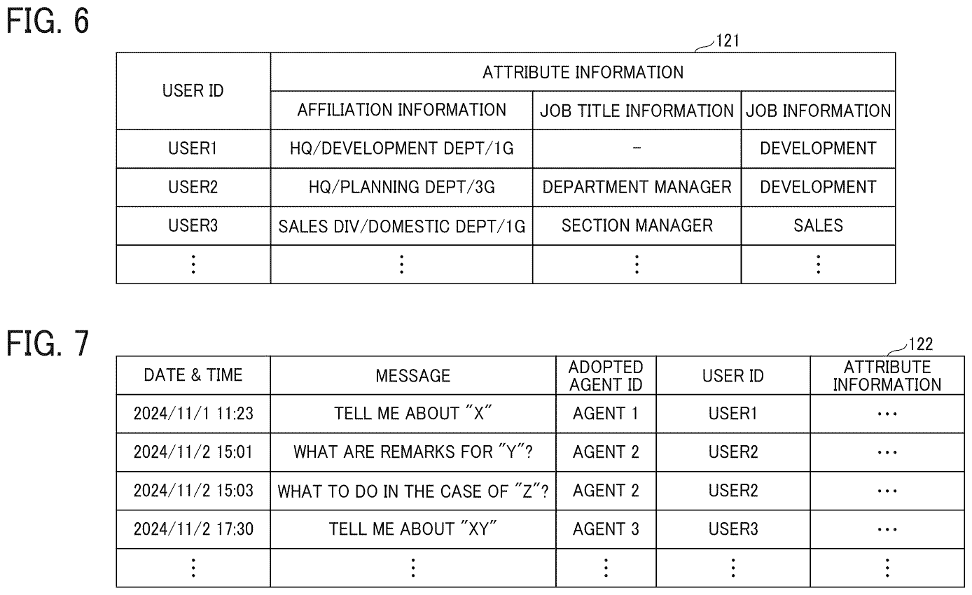

FIG. 6 is a diagram illustrating the user information DB 121. The user information DB 121 illustrated in FIG. 6 stores, for each user, the attribute information of the user in association with the user ID of the user. The attribute information is information indicating the attribute and characteristics of each user. In the example of FIG. 6, the attribute information includes items of affiliation information, job title information, and job information. The affiliation information indicates an organization, such as a department, to which the user belongs in the company X. The job title information indicates the job title of the user. The job information indicates the job description of the user. The attribute information is used to identify a candidate agent for a subject message. The candidate agent is an agent that is likely to have knowledge required to respond to the subject message. Accordingly, it is desirable that the items of the attribute information be selected such that the attribute information is common among users whose knowledge required for business operations is common, and different among users whose knowledge required for business operations is different. This is based on assumption that the messages input to the agent are similar among the users whose knowledge required for business operations is common.

The attribute information of the subject user acquired in step S114 may be referred to as “subject attribute information.”

In steps S115 and S116, the identification unit 12 acquires a subset of the history information having a relatively high relevance to the subject message from the history information DB 122.

FIG. 7 is a diagram illustrating the history information DB 122. The history information DB 122 illustrated in FIG. 7 stores history information including a date and time, a message, an adopted agent ID, a user ID, and attribute information for each message previously received from the user.

The date and time is the date and time when the history information is recorded, and is substantially the same as the date and time when the message is received. The message is the content of the message input by the user. The adopted agent ID is identification information of the agent that has generated the adopted response to the message. The identification information of the agent may be referred to as an “agent ID” in the following description. The user ID is a user ID of the user who has input the message. The attribute information is attribute information of the user who has input the message, such as the affiliation information, the job title information, and the job information of the user. The attribute information may change due to personnel changes. The attribute information recorded in the history information is the attribute information of the user obtained at the time indicated by the date and time of the history information.

A subset of the history information including a message having a relatively high similarity to the subject message is an example of the subset of the history information having a relatively high relevance to the subject message. The degree of similarity between the subject message and the message included in the history information may be evaluated, for example, using an index based on any desired technique of comparing character strings. Alternatively, the subject message and the message included in the history information may each be converted into a semantic vector. In this case, the degree of similarity between two vectors, such as cosine similarity, may be calculated as an index indicating the degree of similarity. In either case, the identification unit 12 acquires a subset of the history information having a higher similarity to the subject message. The identification unit 12 may acquire a predetermined number of subsets of the history information from the top in the order of the degree of similarity. Alternatively, the identification unit 12 may acquire subsets of the history information having the index indicating the similarity higher than a threshold value. In the following description, each of the one or more pieces of history information acquired in step S116 is referred to as “extracted history information.”

In step S117, the identification unit 12 identifies, based on the subject attribute information, the agent IDs of the candidate agents from among the “agent IDs” included in the pieces of extracted history information. The agent IDs of the candidate agents may be referred to as “candidate agent IDs” in the following description. The identification unit 12 identifies, as the candidate agent IDs, the “agent IDs” of one or more pieces of history information including attribute information having a relatively high similarity to the subject attribute information from among the pieces of extracted history information. The attribute information having a relatively high similarity to the subject attribute information is attribute information having a relatively large number of items whose values are identical to those of the subject attribute information. Alternatively, the identification unit 12 may identify, as the candidate agent IDs, agent IDs corresponding to attribute information in which the values of all items are identical to those of the subject attribute information. When the number of pieces of extracted history information is equal to or smaller than a predetermined number, the identification unit 12 may identify, as the candidate agent IDs, the “agent IDs” of all the pieces of extracted history information. Alternatively, when the number of pieces of extracted history information exceeds the predetermined number, the identification unit 12 may identify, as the candidate agent IDs, the “agent IDs” from the predetermined number of pieces of history information. Note that the process of step S117 may be omitted. In such a case, the identification unit 12 identifies, as the candidate agent IDs, the “agent IDs” of all the pieces of extracted history information.

In step S200, a process for generating a response to the subject message is performed for each candidate agent. Accordingly, when K candidate agents are identified, K responses are obtained. The process for generating the response is described in detail later.

In step S118, the identification unit 12 inputs, to the display control unit 16, the identification result including the identified one or more agent IDs and the responses from the candidate agents associated with the agent IDs. In step S119, the display control unit 16 causes a notification based on the identification result to be displayed on the dialog screen 510. Specifically, the display control unit 16 generates display data to be displayed as the notification, and transmits the display data to the communication terminal 20 to cause the notification to be displayed.

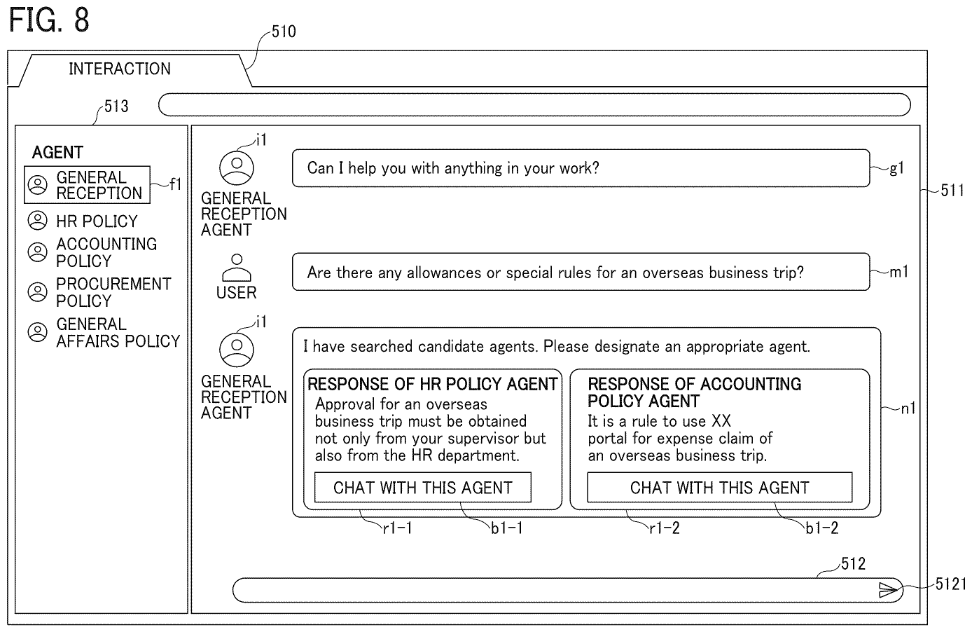

FIG. 8 is a diagram illustrating a first example of the dialog screen 510 displayed based on the identification result of the candidate agents. In FIG. 8, identical or similar reference signs denote identical or similar elements illustrated in FIG. 5, and redundant descriptions thereof are omitted unless otherwise required. On the dialog screen 510 illustrated in FIG. 8, a message m1 and a notification n1 are added.

The message m1 is the subject message that the user has input in the message input area 512 in step S111. When the user clicks the send icon 5121, the subject message input in the message input area 512 is displayed in the interaction display area 511.

The notification n1 is a display content additionally displayed in step S119. The notification n1 is a notification for prompting designation of one agent out of the candidate agents as an adopted agent, and includes a response area for each candidate agent. The response area is an area presenting a response generated by a candidate agent corresponding to the response area. In FIG. 8, in response to the message m1 “Are there any allowances or special rules for an overseas business trip?,” two agents including the “HR policy” agent and the “accounting policy” agent are displayed as candidate agents. Accordingly, the notification n1 includes a response area r1-1 presenting the response generated by the “HR policy” agent and a response area r1-2 presenting the response generated by the “accounting policy” agent. Each response area includes a button for designating a candidate agent corresponding to the response area as an adopted agent. The response area r1-1 includes a button b1-1, and the response area r1-2 includes a button b1-2. In the present embodiment, the response area includes the button for designating a candidate agent corresponding to the response area as an adopted agent. However, in another embodiment, the response area may not include a button. In other words, the candidate agent may be designating by designating the response area itself. Each response area may include a graphic such as a star mark, which represents an evaluation value serving as a recommendation level. The evaluation value may be calculated based on the result of an evaluation of the similarity between the subject message and the history information when acquiring the extracted history information (S115, S116) or when identifying candidate agent IDs from among the agent IDs of the extracted history information based on the subject attribute information (S117), or an evaluation of the similarity between the subject attribute information and the attribute information of the extracted history information. The user may designate an adopted agent based on the number of star marks.

When the user designates one of the buttons b1-1 and b1-2, the communication terminal 20 displays, according to a definition such as a script included in the display data of the dialog screen 510, a response generated by the candidate agent associated with the designated button on the dialog screen 510 as a response adopted for the subject message, which may be referred to as an “adopted response” in the following description. This is based on assumption that the display control unit 16 generates display data of the dialog screen 510 so that, when a button of any response area is designated, a response included in the response area is displayed as an adopted response.

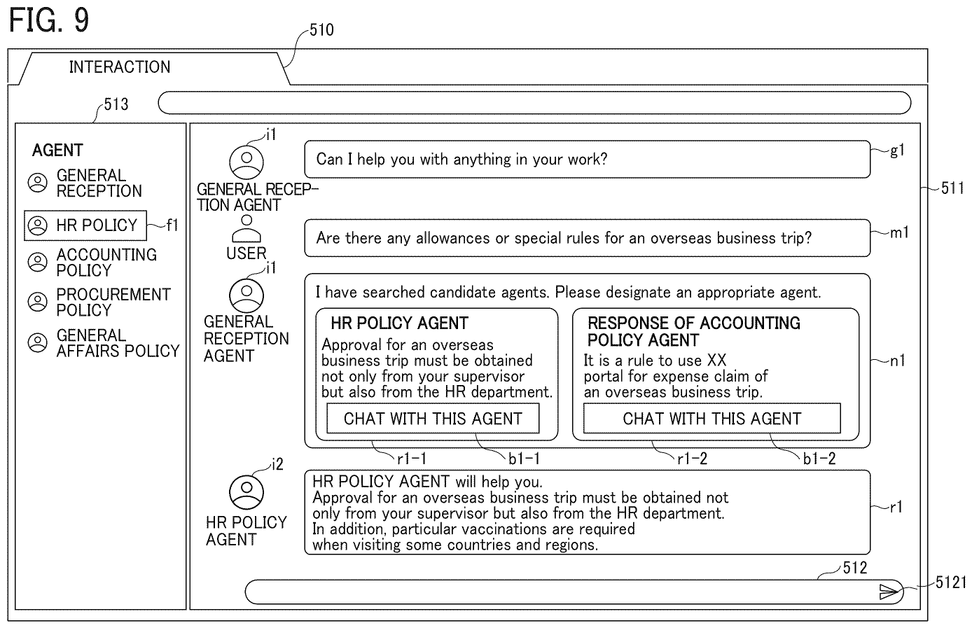

FIG. 9 is a diagram illustrating a display example of an adopted response. In FIG. 9, identical or similar reference signs denote identical or similar elements illustrated in FIG. 8, and redundant descriptions thereof are omitted unless otherwise required. On the dialog screen 510 illustrated in FIG. 9, an icon i2 and a response r1 are added.

The response r1 is an adopted response to the message m1. In FIG. 11, a case is illustrated, in which the “HR policy” agent is designated. Accordingly, the response generated by the “HR policy” agent, which is a response generated based on the “HR policy,” is displayed as the response r1.

The icon i2 represents the “HR policy” agent. Accordingly, the entity represented by the icon i2 is actually different from that of the icon i1.

In FIG. 9, the “HR policy” in the agent list display area 513 is surrounded by the frame line f1. The presence of the frame line f1 indicates that the current conversational partner (i.e., the adopted agent) has been changed to the “HR policy” agent.

In step S120, the communication terminal 20 transmits the agent ID of the agent corresponding to the designated button to the information processing apparatus 10. The agent ID of the agent corresponding to the designated button may be referred to as a “designated agent ID” in the following description. In step S121, in response to receiving the designated agent ID, the reception unit 11 of the information processing apparatus 10 inputs the designated agent ID to the identification unit 12. In step S122, the identification unit 12 identifies the designated agent ID as the agent ID of the adopted agent and records history information for the subject message in the history information DB 122 of FIG. 7. At this point, the current date and time, the subject message, the designated agent ID, the user ID of the subject user, and the attribute information of the subject user are applied to the “date and time,” the “message,” the “adopted agent ID,” the “user ID,” and the “attribute information” of the history information, respectively.

Between the processes in steps S121 and S122, the agent associated with the designated agent ID may be caused to newly generate a response to the subject message. In other words, the same process as that in step S200 may be performed for the agent. In this case, the identification unit 12 records history information including the newly generated response in the history information DB 122 of FIG. 7 in step S122. Subsequently, the identification unit 12 inputs the response to the display control unit 16. The display control unit 16 transmits, to the communication terminal 20, display data of the dialog screen 510 for displaying the response as an adopted response. The communication terminal 20 displays the dialog screen 510 illustrated in FIG. 9 based on the display data. In this case, the communication terminal 20 does not need to perform the process for displaying the adopted response based on, for example, the script.

In step S117 of FIG. 4, there may be a case in which only one candidate agent is identified. For example, there may be a case in which only one piece of history information that includes a message having a degree of similarity to the subject message exceeding the threshold value, or a case in which only one piece of history information that includes attribute information having a similarity to the subject attribute information is equal to or greater than a certain level. In this case, on the dialog screen 510, a notification including only one response area may be presented. Alternatively, a response generated by the one candidate agent may be displayed as an adopted response in order to reduce the workload for the user to perform designation.

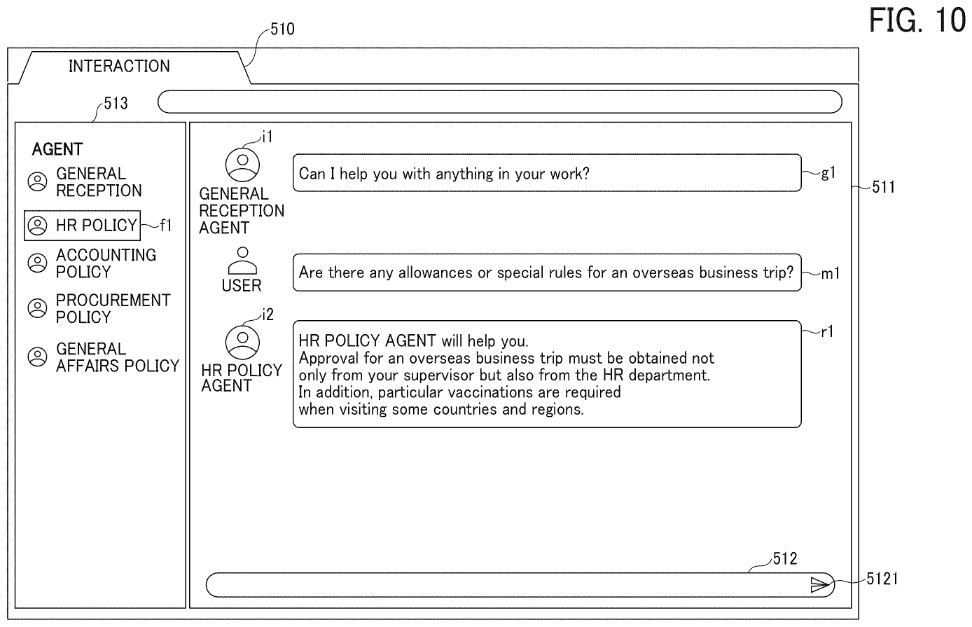

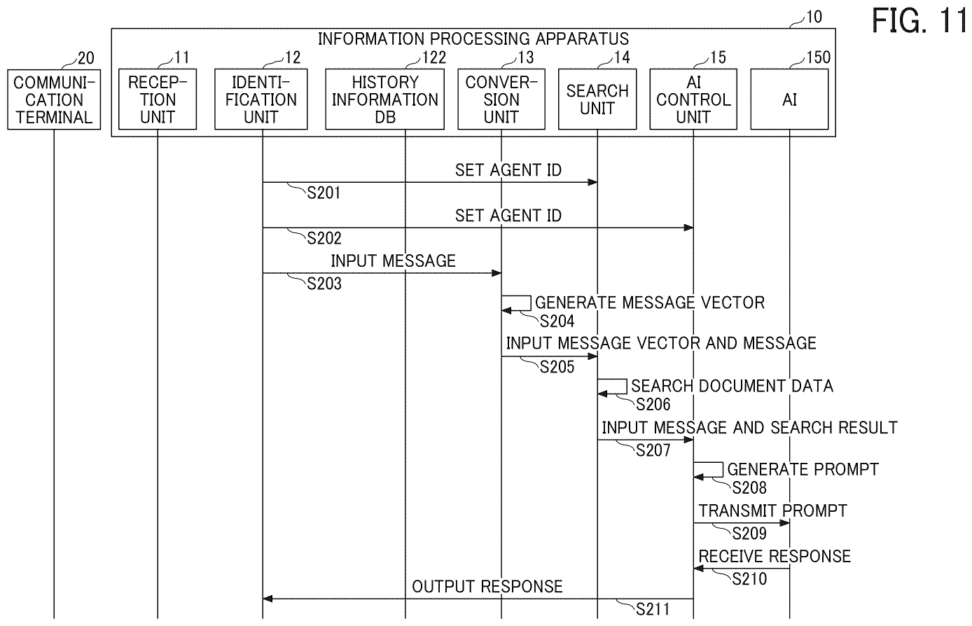

FIG. 10 is a diagram illustrating the dialog screen 510 based on the identification result that includes only one candidate agent. In FIG. 10, identical or similar reference signs denote identical or similar elements illustrated in FIG. 9, and redundant descriptions thereof are omitted unless otherwise required. FIG. 10 corresponds to an example in which only the “HR policy” agent is identified as a candidate agent. In this case, on the dialog screen 510, the notification n1 is not presented but the response r1 generated by the “HR policy” agent is presented below the message m1 as an adopted response.

The process of step S200 is described in detail below.

FIG. 11 is a sequence diagram illustrating a process performed by an agent for generating a response to a subject message. In step S200, the process in FIG. 11 is repeated for each candidate agent. In FIG. 11, the candidate agent that is a processing target is referred to as a “subject agent,” and the agent ID of the subject agent is referred to as a “subject agent ID.”

In steps S201 and S202, the identification unit 12 sets a subject agent ID in the search unit 14 and the AI control unit 15. This setting is performed to cause the behavior of the search unit 14 and the AI control unit 15 to correspond to the subject agent associated with the subject agent ID.

In step S203, the identification unit 12 inputs the subject message to the conversion unit 13. In step S204, the conversion unit 13 converts the input subject message into a semantic vector to generate a message vector. In step S205, the conversion unit 13 inputs the message vector and the subject message to the search unit 14. The message vector may be referred to as a “subject message vector” in the following description.

In step S206, the search unit 14 searches, based on the subject message vector, the data DB 123 corresponding to the subject agent ID set in step S201 (that is, the data DB 123 corresponding to the subject agent) to obtain a search result. Specifically, the search unit 14 compares the chunk vector and the message vector stored in the data DB 123 corresponding to the subject agent ID for each piece of document data and each chunk to identify a chunk having a similarity to each piece document data and extract some chunks having a relatively high similarity to the subject message. The search unit 14 generates, for each of the extracted chunks having a similarity, information including the related document information of the chunk having a similarity as a search result. In step S207, the search unit 14 inputs the subject message and the search result to the AI control unit 15.

In step S208, the AI control unit 15 applies the search result and the subject message to a system prompt to generate a prompt. The system prompt is a template of a prompt to be input to the AI 150, and is prepared in advance. A simple example of the system prompt is described below.
<Example of system prompt starts.>
The message from the user is as follows.
{Message}
Please generate a response to the message by referring to the following document.
{Collection of chunks having a similarity associated with the search result}
<Example of system prompt ends.>

In this case, the AI control unit 15 generates a prompt by applying the subject message to the {Message} portion of the system prompt, and applying the collection of the chunks having a similarity associated with the search result provided by the search unit 14 to the {Collection of chunks having a similarity associated with the search result} portion of the system prompt. By inputting the prompt generated in this manner to the AI 150, the AI 150 generates a response by using even the information included in the collection of the chunks having a similarity associated with the search result, which includes information that the AI 150 has not learned. Accordingly, the response from the AI 150 may be based on the collection of the chunks having a similarity associated with the search result.

The system prompt may be prepared for each agent. Further, the system prompt may differ for each agent. In this case, the AI control unit 15 may generate a prompt by applying the subject message and the search result to the system prompt corresponding to the subject agent ID set in step S202.

In step S209, the AI control unit 15 transmits the generated prompt to the AI 150. In step S210, the AI control unit 15 receives, from the AI 150, a response generated by the AI 150 to which the prompt is input. In step S211, the AI control unit 15 outputs the response, which may be referred to as a “subject response” in the following description, to the identification unit 12. The identification unit 12 records the subject response as a response generated by the subject agent.

When the processes in steps S201 to S211 are performed for all the candidate agents, the identification unit 12 generates an identification result that includes the responses generated by all the candidate agents.

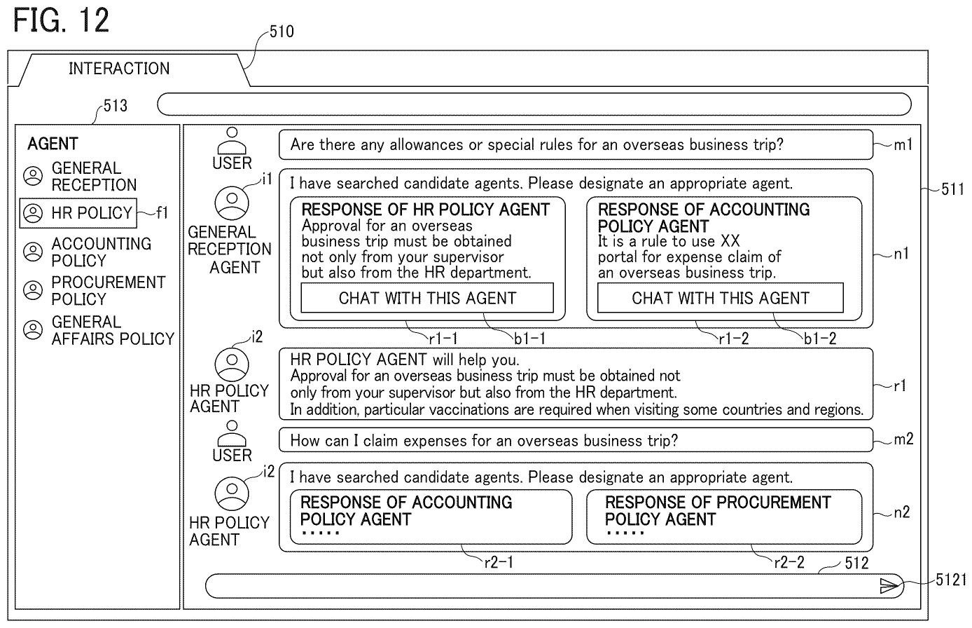

When the user newly inputs a message in the message input area 512, the processes in steps S111 to S119 of FIG. 4 are performed again for the message as the subject message. As a result, the display content of the dialog screen 510 changes, for example, as illustrated in FIG. 12.

FIG. 12 is a diagram illustrating a first example of the dialog screen 510 displayed based on the identification result of the candidate agents identified in the second or subsequent time according to the first embodiment. In FIG. 12, identical or similar reference signs denote identical or similar elements illustrated in FIG. 9, and redundant descriptions thereof are omitted unless otherwise required. On the dialog screen 510 illustrated in FIG. 12, a message m2 and a notification n2 are added. The greeting sentence g1, which is displayed in FIG. 10, is not displayed as the window scrolls up. The message m2 is a message input by the user after the response r1 is displayed. The notification n2 is a display content added in the process of step S119 performed for the message m2. The notification n2 indicates that the candidate agents for the message m2 are the “accounting policy” agent and the “procurement policy” agent, and includes response areas r2-1 and r2-2 corresponding to the respective agents. The response areas r2-1 and r2-2 each include a button, which is omitted in FIG. 12. When a button of any response area is designated, the response of the response area is displayed as an adopted response, and the processes in step S120 and the subsequent steps of FIG. 4 are performed.

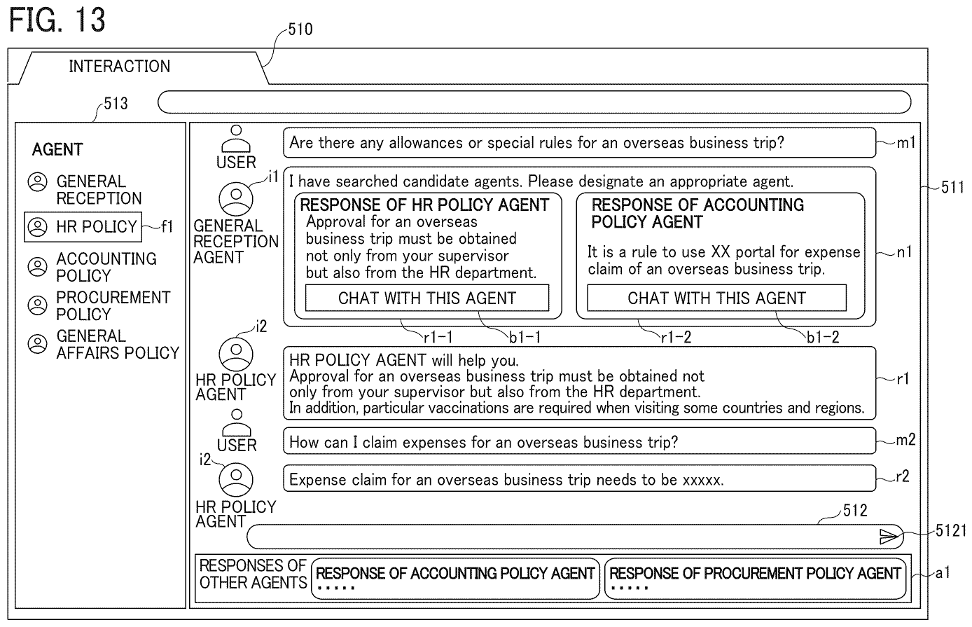

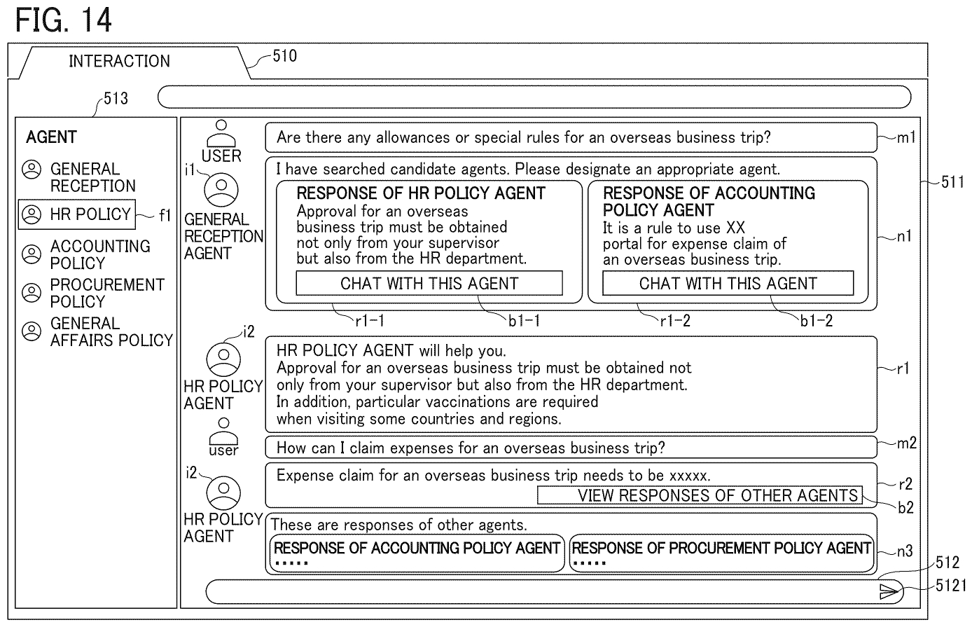

Instead of the dialog screen 510 illustrated in FIG. 12, the dialog screen 510 illustrated in FIG. 13 or 14 may be displayed. FIG. 13 is a diagram illustrating a second example of the dialog screen 510 displayed based on the identification result of the candidate agents identified in the second or subsequent time according to the first embodiment. In FIG. 13, identical or similar reference signs denote identical or similar elements illustrated in FIG. 12, and redundant descriptions thereof are omitted unless otherwise required.

On the dialog screen 510 of FIG. 13, a response r2 is presented, instead of the notification n2. The response r2 is a response to the message m2, which is generated by the “HR policy” agent that is the adopted agent at that time (i.e., the agent that has responded to the message m1). In FIG. 13, the response generated by the adopted agent is displayed as the adopted response.

On the dialog screen 510 of FIG. 13, a response selection area a1 is also presented. The response selection area a1 includes a response area for each candidate agent other than the adopted agent. When a button of each response area, which is omitted in FIG. 13, is designated, the processes in step S120 and the subsequent steps in FIG. 4 are performed.

FIG. 14 is a diagram illustrating a third example of the dialog screen 510 displayed based on the identification result of the candidate agents identified in the second or subsequent time according to the first embodiment. In FIG. 14, identical or similar reference signs denote identical or similar elements illustrated in FIG. 13, and redundant descriptions thereof are omitted unless otherwise required.

On the dialog screen 510 of FIG. 14, a button b2 is arranged, which corresponds to the response r2. When the button b2 is designated by the user, the communication terminal 20 displays a notification n3 according to a definition such as a script included in the display data of the dialog screen 510. The notification n3 includes a response area for each candidate agent other than the adopted agent, as in the response selection area a1 of FIG. 13. In other words, on the dialog screen 510 of FIG. 14, when the user explicitly instructs a response from another candidate agent to be displayed, the response is displayed.

The display format illustrated in FIG. 13 or 14 may be used to display the identification result of the candidate agents identified not only in the second or subsequent time but also in the first time.

In step S117 of FIG. 4, there may be a case in which even one candidate agent is not identified at all. For example, there may be a case in which the history information is not sufficiently accumulated, a case in which there is no history information that includes a message having a degree of similarity to the subject message exceeding the threshold value, a case in which there is no history information that includes attribute information having a similarity to the subject attribute information being equal to or greater than a certain level. In such a case, the following two cases are considered.

In the first case, the identification unit 12 does not perform the process in step S200, and inputs the identification result indicating that there is no candidate agent to the display control unit 16 in step S118. In step S119, the display control unit 16 causes a notification indicating that there is no agent that can respond to the subject message to be displayed on the dialog screen 510. Specifically, the display control unit 16 generates display data to be displayed as the notification, and transmits the display data to the communication terminal 20 to cause the notification to be displayed. In this case, the processes of step S120 and the subsequent steps are not performed. Accordingly, the user needs to input the message again, in a different expression.

In the second case, the process in step S200 is performed only once. In the execution of the process in step S200, the processes in steps S201 and S202 of FIG. 11 are not performed and the processes in step S203 and the subsequent steps are performed. In this case, since the designated agent ID is not set (that is, the adopted agent is not identified) in step S206, the search unit 14 searches all the data DBs 123-1 to 123-N based on the subject message vector to obtain a search result. In step S208, in the case where the system prompt differs for each agent, the AI control unit 15 applies the subject message and the search result provided by the search unit 14 to the system prompt to be used when the agent is not identified, to generate a prompt. The response generated by the AI 150 to such a prompt is likely to have a quality lower than the quality of the response when the adopted agent is identified. In the second case, however, still some outputs can be presented to the user. The response is presented to the user as a response from the general reception agent.

When there are one or more interactive AIs that automatically generate responses to the message from the user, it is difficult to designate an interactive AI that outputs an appropriate response to the message of the user.

However, as described above, according to the first embodiment, an agent that has responded to a message having a relatively high similarity to a message input from the user is identified as a candidate agent. In addition, an agent that has responded to a message from a user who has attribute information having a relatively high similarity to the user who has input the message can be identified as a candidate agent. Accordingly, an interactive AI suitable for the message input from the user can be identified. Thus, each candidate agent is caused to generate a response and displayed in a selectable manner. As a result, an interactive AI suitable for a message input from the user can be designated.

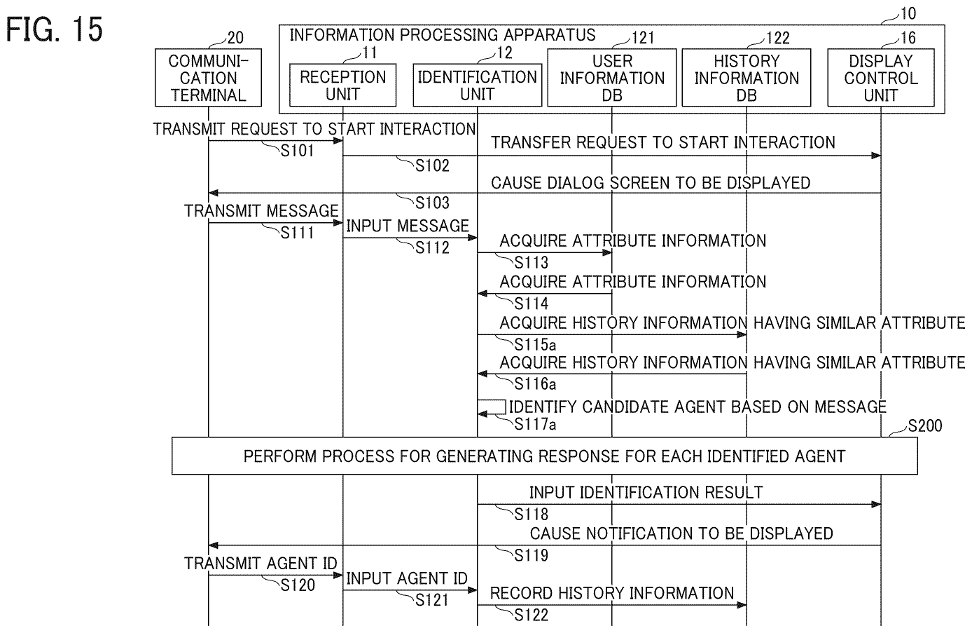

A second embodiment is described below. In the second embodiment, differences from the first embodiment are described. Accordingly, the features that are not particularly mentioned are substantially the same as those of the first embodiment. In the second embodiment, the process in FIG. 4 is replaced with the process in FIG. 15.

FIG. 15 is a sequence diagram illustrating a process of interaction between the user and the agent according to the second embodiment. In FIG. 15, identical or similar step numbers denote identical or similar steps illustrated in FIG. 4, and redundant descriptions thereof are omitted unless otherwise required. In FIG. 15, the processes in steps S115, S116, and S117 of FIG. 4 are replaced with the processes in steps S115a, S116a, and S117a.

In steps S115a and S116a, the identification unit 12 acquires, from the history information DB 122, a subset of the history information (“extracted history information”) including the attribute information having a relatively high similarity to the subject attribute information. The degree of similarity is evaluated in a substantially similar manner as described in the process in step S117 of the first embodiment.

In step S117a, the identification unit 12 identifies, as candidate agent IDs, the “agent IDs” of one or more pieces of history information each including a message having a relatively high similarity to the subject message, from among the extracted history information. The degree of similarity is evaluated in a substantially similar manner as described in the processes in steps S115 and S116 of the first embodiment.

The other processes may be the same or substantially the same as those in the first embodiment.

As described above, according to the second embodiment, the same effects as those of the first embodiment can be obtained.

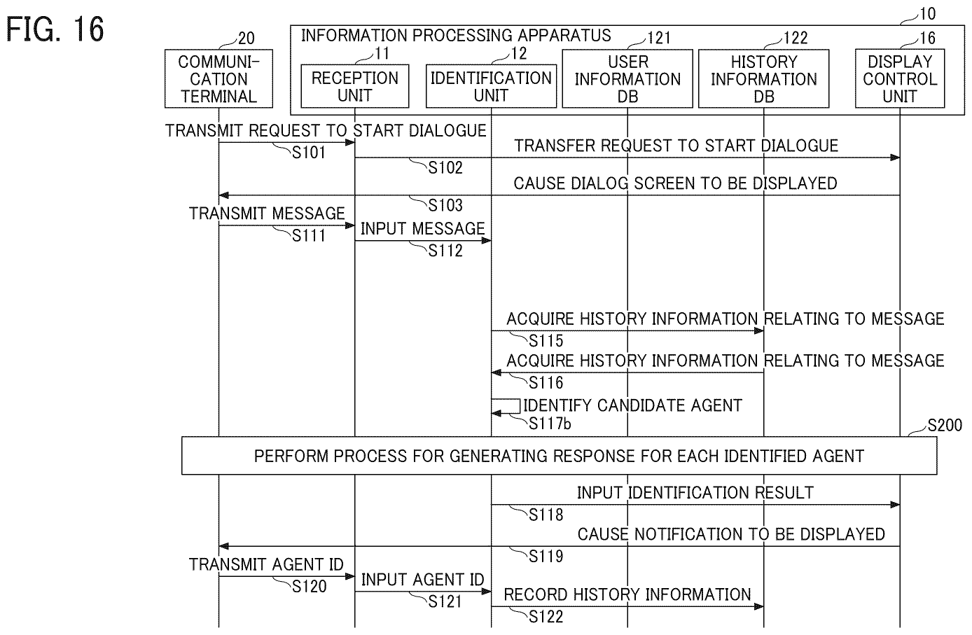

A third embodiment is described below. In the third embodiment, differences from the first and second embodiments are described. Accordingly, the features that are not particularly mentioned are substantially the same as those of the first or second embodiment. In the third embodiment, the process in FIG. 4 or 15 is replaced with the process in FIG. 16.

FIG. 16 is a sequence diagram illustrating a process of interaction between the user and the agent according to the third embodiment. In FIG. 16, identical or similar step numbers denote identical or similar steps illustrated in FIG. 4 or 15, and redundant descriptions thereof are omitted unless otherwise required.

In FIG. 16, the processes in steps S113 and S114 are not performed, and a process in step S117b is performed. In step S117b, the identification unit 12 identifies, as candidate agent IDs, the “agent IDs” of one or more pieces of the extracted history information acquired in steps S115 and S116. The identification unit 12 may narrow down the extracted history information to one or more pieces of history information that include attribute information having an even higher similarity to the subject attribute information, and identify the “agent IDs” of the narrowed down one or more pieces of history information as candidate agent IDs. After the process in step S117b is performed, the processes in steps S200 and S118 to S122 are performed in a substantially similar manner as illustrated in FIG. 4.

A fourth embodiment is described below. In the fourth embodiment, differences from the first to third embodiments are described. Accordingly, the features that are not particularly mentioned are substantially the same as those of the first to third embodiments.

The fourth embodiment differs from the above-described embodiments in the process for a message of the second or subsequent interaction (that is, the process when a message is received in a state where an adopted agent is identified).

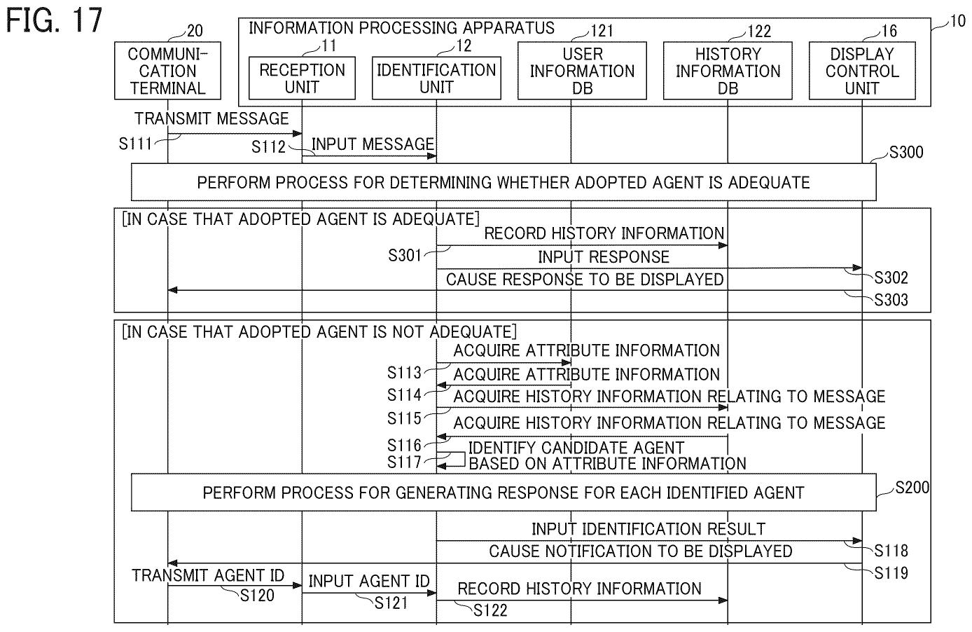

FIG. 17 is a sequence diagram illustrating a process of the second or subsequent interaction according to the fourth embodiment. In FIG. 17, identical or similar step numbers denote identical or similar steps illustrated in FIG. 4, and redundant descriptions thereof are omitted unless otherwise required.

The message (i.e., the subject message) transmitted by the communication terminal 20 in step S111 of FIG. 17 is a message of the second or subsequent interaction, which is a message input in a state where an adopted agent is identified.

In step S112, in response to receiving the subject message, the reception unit 11 inputs the subject message to the identification unit 12. In step S300, the identification unit 12 performs a determination process to determine whether the adopted agent currently designated (that is, the agent designated for the last message) is adequate as an agent that generates a response to the subject message. For example, the process in FIG. 11 is performed for the adopted agent currently designated. The identification unit 12 determines whether the response obtained as a result of the process in FIG. 11 is appropriate for the subject message. Such a determination may be made using a known technique based on a comparison between the character strings of the subject message and the response. Alternatively, the identification unit 12 may inquire of the AI 150 whether the response to the subject message is appropriate. Still alternatively, the identification unit 12 may determine whether the adopted agent is adequate, based on the search result obtained in step S206 when the process in FIG. 11 is performed for the adopted agent. Specifically, the identification unit 12 may determine that the adopted agent is adequate when the number of chunks having a degree of similarity to the subject message vector equal to or greater than the threshold value is equal to or greater than a predetermined number. When the number of chunks having a degree of similarity to the subject message vector equal to or greater than the threshold value is smaller than the predetermined number, the identification unit 12 may determine that the adopted agent is not adequate.

In the case where the adopted agent is determined to be adequate, in step S301, the identification unit 12 records history information for the subject message in the history information DB 122 of FIG. 7. At this point, the current date and time, the subject message, the agent ID of the adopted agent, the user ID of the subject user, and the attribute information of the subject user are applied to the “date and time,” the “message,” the “adopted agent ID,” the “user ID,” and the “attribute information” of the history information, respectively. The user ID and attribute information of the subject user may be the same as those in the history information for the last message. In step S302, the identification unit 12 inputs the response generated by the adopted agent in step S300 to the display control unit 16. In step S303, the display control unit 16 causes the subject response to be displayed on the dialog screen 510 displayed on the communication terminal 20. Specifically, the display control unit 16 generates display data to be displayed as the subject response, and transmits the display data to the communication terminal 20 to cause the subject response to be displayed. In this case, when the subject message is the message m2 in FIG. 13, the response r1 is displayed below the message m2. However, at this point, unlike FIG. 13, the response selection area a1 is not displayed.

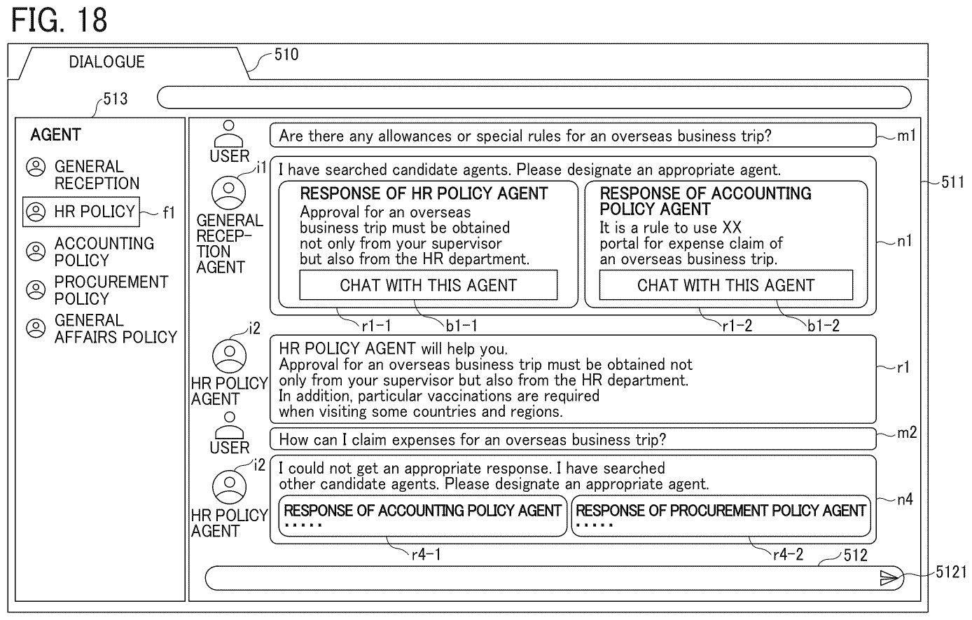

On the other hand, in the case where the adopted agent is determined not to be adequate, the processes in steps S113 to S117, S200, S118, and S119 are performed. In this case, the dialog screen 510 displayed in step S119 is, for example, as illustrated in FIG. 18.

FIG. 18 is a diagram illustrating the dialog screen 510 displayed when the adopted agent is determined not be adequate according to the fourth embodiment. In FIG. 18, identical or similar reference signs denote identical or similar elements illustrated in FIG. 12, and redundant descriptions thereof are omitted unless otherwise required.

On the dialog screen 510 in FIG. 18, instead of the notification n2, a notification n4 is presented. The notification n4 includes a message beginning with “I could not get an appropriate response.” as a response from the “HR policy” agent, which is the adopted agent currently designated, and response areas r4-1 and r4-2 for respective candidate agents. The response areas r4-1 and r4-2 each include a button, which is omitted in FIG. 18.

When a button of any response area is designated, the processes in steps S120 to S122 of FIG. 17 are performed.

As described above, according to the fourth embodiment, when the adopted agent is adequate, the execution of the processes for generating responses performed by the other agents can be avoided.

A modification of the first to fourth embodiments is described below.

In the process of step S117 of FIG. 4 or 17, step S117a of FIG. 15, or step S117b of FIG. 16, when multiple pieces of extracted history information are determined to have the highest similarity to the subject attribute information, the identification unit 12 identifies, as the candidate agent, the “agent ID” of one piece of history information that includes a message having the highest similarity to the subject message among the multiple pieces of extracted history information. In the case where there are multiple pieces of history information each including a message having the highest similarity to the subject message among the multiple pieces of extracted history information, the identification unit 12 may randomly designate one piece of the history information or may designate one piece of history information based on another designation criterion. In this case, the processes in steps S118 to S122 are not performed. In step S201, the identification unit 12 sets the identified agent ID in the search unit 14. In this case, the dialog screen 510 illustrated in FIG. 10 is displayed with respect to the message m1.

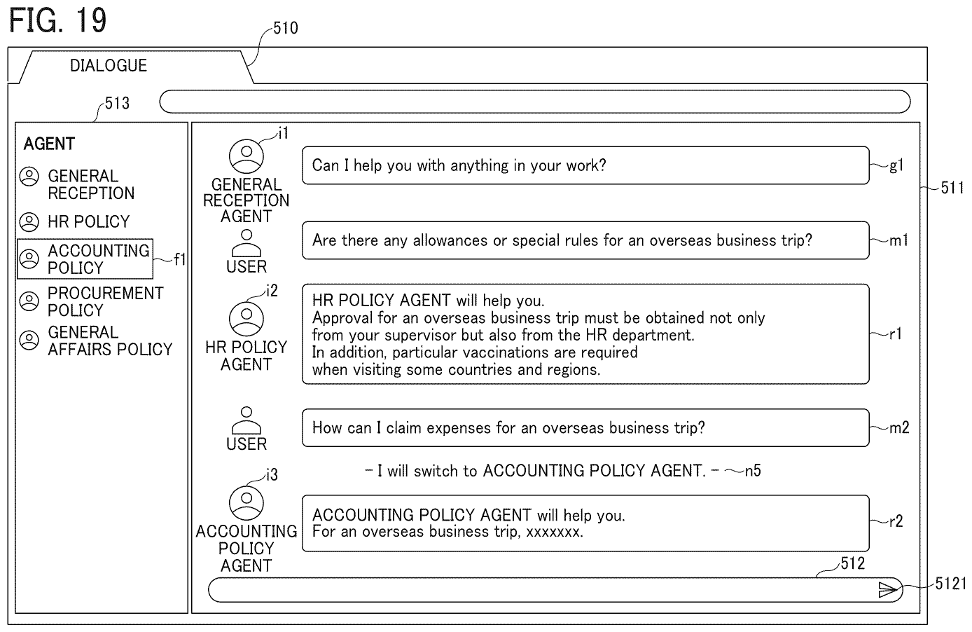

When the user newly inputs a message in the message input area 512, for example, the processes in steps S111 to S117, S200, S118, and S119 of FIG. 4 are performed again for the message newly input as the subject message. As a result, the display content of the dialog screen 510 of FIG. 10 changes, for example, as illustrated in FIG. 19.

FIG. 19 is a diagram illustrating the dialog screen 510 on which a second or subsequent response is presented according to a modification. In FIG. 19, identical or similar reference signs denote identical or similar elements illustrated in FIG. 12 or 13, and redundant descriptions thereof are omitted unless otherwise required.

In FIG. 19, the response r2 is displayed in response to the message m2. In FIG. 19, a case is illustrated, in which the adopted agent that has generated the response r2 is the “accounting policy” agent. In the case of switching agents without allowing the user to designate an agent, a notification n5 may be displayed, which includes a character string indicating the switching of the agents.

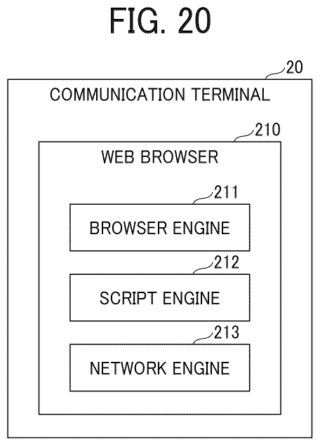

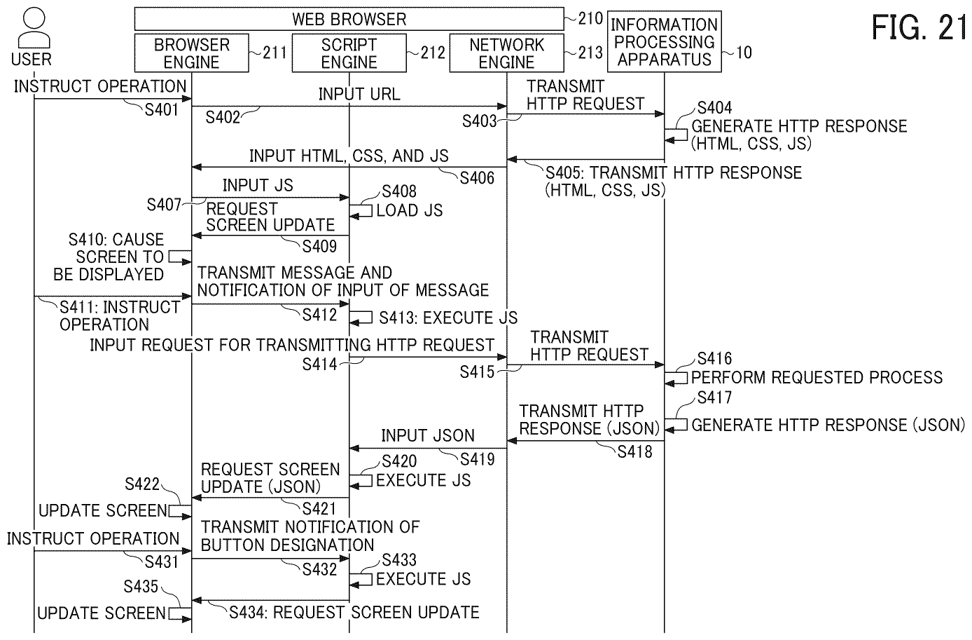

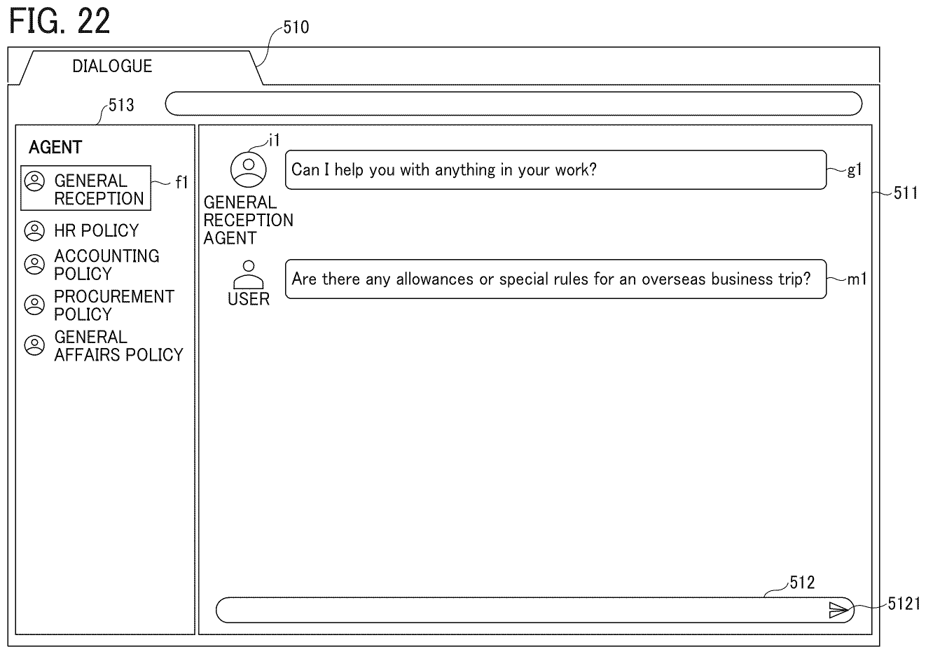

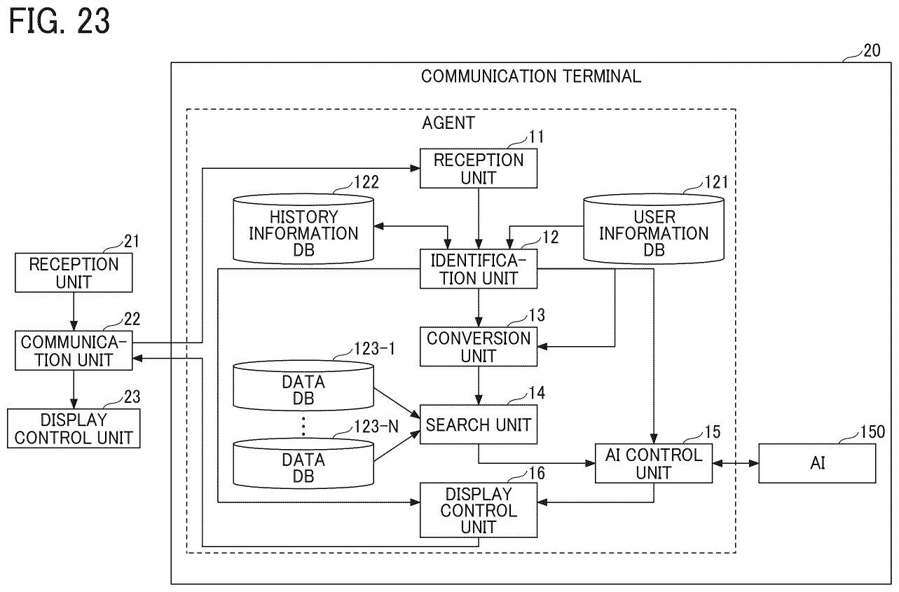

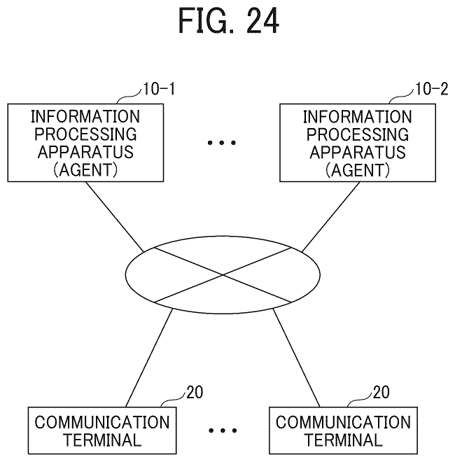

As described above, in the modification of the first to fourth embodiments, the adopted agent is automatically identified without designation operation performed by the user. As a result, the workload for the operation performed by the user is reduced. A fifth embodiment is described below. In the fifth embodiment, differences from the first embodiment are described. Accordingly, the features that are not particularly mentioned are substantially the same as those of the first embodiment. In the fifth embodiment, a case is described in which the communication terminal 20 displays various screens using a web browser and the information processing apparatus 10 has a function as a web server that executes a web application. FIG. 20 is a block diagram illustrating a functional configuration of the communication terminal 20 according to the fifth embodiment. In FIG. 20, the communication terminal 20 includes a web browser 210. The web browser 210 is a typical web browser, and includes a browser engine 211, a script engine 212, and a network engine 213. The browser engine 211 interprets HyperText Markup Language (HTML) data and Cascading Style Sheets (CSS) data that form a web page and renders the web page for display. The script engine 212 executes a script (for example, JavaScript™) that forms a web page. The network engine 213 transmits a HyperText Transfer Protocol (HTTP) request and receives an HTTP response. FIG. 21 is a sequence diagram illustrating a process related to screen transition according to the fifth embodiment. In step S401, the user instructs the web browser 210 to display the dialog screen 510. In step S402, the browser engine 211 inputs, to the network engine 213, a Uniform Resource Locator (URL) that is associated with the instruction of the display and serves as a destination of an HTTP request to the information processing apparatus 10. In step S403, the network engine 213 transmits the HTTP request to a destination indicated by the URL. For example, the URL may be registered in a bookmark of the web browser 210, may be associated with a menu of a menu screen provided by the information processing apparatus 10, or may be directly input by the user. The information indicating the URL may be searched by the user using a search engine. In response to the HTTP request, in step S403, the display control unit 16 of the information processing apparatus 10 generates an HTTP response that includes web content data corresponding to the URL to which the HTTP request is addressed. The web content data includes HTML data, CSS data, and a script. The script may be referred to as a “JS” in the following description. The web content is used to display multiple web pages to be displayed in the following description. The JS includes multiple JS scripts that execute processing according to an operation performed on each screen. In step S405, the display control unit 16 transmits the HTTP response generated in step S404 to the communication terminal 20. In response to receiving the HTTP response, in step S406, the network engine 213 of the communication terminal 20 inputs the HTML data, the CSS data, and the JS included in the HTTP response to the browser engine 211. In step S407, the browser engine 211 inputs the JS received from the network engine 213 to the script engine 212. In step S408, the script engine 212 loads the JS. In step S409, the script engine 212 requests the browser engine 211 to update the screen. Updating the screen includes displaying a new screen. The HTTP response generated in step S404 may include the file name of the JS, instead of the substance of the JS. In this case, in step S408, the script engine 212 accesses an external file based on the file name, and downloads the JS. This is a way of reading the JS as an external file. In step S410, the browser engine 211 causes the dialog screen 510 of FIG. 5 to be displayed based on the HTML data and the CSS data. In step S411, the user inputs a message to the message input area 512 on the dialog screen 510 of FIG. 5 and clicks the send icon 5121. In response to the user operation, the display content of the dialog screen 510 changes as illustrated in FIG. 22. In FIG. 22, the message that has been input in the message input area 512 of FIG. 5 is displayed as the message m1 in the interaction display area 511. In step S412, the browser engine 211 transmits, to the script engine 212, a notification indicating that the message has been input and the message. In response to the notification from the browser engine 211, in step S413, the script engine 212 executes one of the multiple JS scripts to transmit the input message to the information processing apparatus 10. In step S414, the script engine 212 inputs, to the network engine 213, a transmission request for transmitting an HTTP request according to the input of the message, together with the message. In step S415, the network engine 213 transmits the HTTP request including the message to the information processing apparatus 10. When the reception unit 11 of the information processing apparatus 10 receives the HTTP request, in step S416, the information processing apparatus 10 executes processing requested by the HTTP request. The processes in steps S112 to S118 of FIG. 4 are performed for the HTTP request according to the input of the message on the dialog screen 510 illustrated in FIG. 5. As a result, for each candidate agent, an identification result including the agent ID and the response from the candidate agent is obtained as a processing result. In step S417, the display control unit 16 generates an HTTP response that includes JavaScript™ Object Notation (JSON) in which the identification result serving as the processing result is described. In step S418, the display control unit 16 transmits the HTTP response to the communication terminal 20. The HTTP response corresponds to the process in step S119 of FIG. 4. In response to receiving the HTTP response, in step S419, the network engine 213 of the communication terminal 20 inputs, to the script engine 212, the JSON included in the HTTP response. The JSON included in the HTTP response may be referred to as “identification result JSON” in the following description. In step S420, the script engine 212 executes one of the multiple JS scripts to update the display content of the web page based on the JSON. In step S421, the script engine 212 requests the browser engine 211 to update the display content of the web page based on the JSON. In step S422, the browser engine 211 updates the display content of the dialog screen 510 from the state illustrated in FIG. 22 to the state illustrated in FIG. 8, based on the HTML data and the CSS data acquired in step S406 and the identification result JSON. In step S431, the user designates one of the buttons b1-1 and b1-2 on the dialog screen 510 of FIG. 8. In step S432, the browser engine 211 notifies the script engine 212 of the designation of one of the button b1-1 and b1-2. In response to the notification from the browser engine 211, in step S433, the script engine 212 executes one of the multiple JS scripts to update the display content of the web page based on the identification result JSON. By executing the script, in step S434, the script engine 212 requests the browser engine 211 to update the display content of the web page. In step S435, the browser engine 211 updates the display content of the dialog screen 510 from the state illustrated in FIG. 8 to the state illustrated in FIG. 9, based on the HTML data and the CSS data acquired in step S406 and the identification result JSON. As described above, in the fifth embodiment, web content data is transmitted to the communication terminal 20. The web content data is data for displaying a first web page and a second web page. The first web page presents a screen (for example, the dialog screen 510 of FIG. 4) for receiving input of a first message from the user. The second web page (for example, the dialog screen 510 of FIG. 8) presents multiple responses and presents the one or more specific interactive AIs corresponding to the multiple responses in a selectable manner. The web content data includes a script for executing at least a process for transmitting the first message input on the first web page to the communication terminal 20 and a process for displaying the second web page on which the one or more specific interactive AIs identified by the identification unit 12 are presented. In addition, when the reception unit 11 receives the HTTP request, which is transmitted by executing the script on the communication terminal 20 and includes the first message input on the first web page displayed on the communication terminal 20 based on the web content data, the identification unit 12 identifies one or more specific interactive AIs to be caused to generate responses to the first message, based on the content of the first message. Further, the display control unit 16 transmits, as a response to the HTTP request, an HTTP response including information indicating the identified specific interactive AIs to the communication terminal 20 to cause the communication terminal 20 to execute the script and display the second web page. Transmitting the HTTP response to the communication terminal 20 is the process in step S418, which corresponds to the process in step S119 of FIG. 4. As described above, the web content data including the JS scripts used for executing the processing according to the operation on the first web page, the web page (e.g., the second web page) after the screen transition is performed according to the processing, and the JS scripts used for executing the processing according to the operation on each web page after the screen transition, is transmitted to the communication terminal 20 at a time in step 405. Since each screen transition is executed by the JS, the communication terminal 20 does not need to download the web content data after the screen transition again. Accordingly, the display speed of, for example, the second screen is increased and the communication load in the screen transition is reduced. Although the primary functions of the information processing system 1 are implemented by the information processing apparatus 10 in the above-described embodiments, the communication terminal 20 may have the functions of the information processing apparatus 10. FIG. 23 is a block diagram illustrating a functional configuration of the communication terminal 20 that has the functions of the information processing apparatus 10. In FIG. 23, identical or similar reference signs denote identical or similar elements illustrated in FIG. 3, and redundant descriptions thereof are omitted unless otherwise required. As described above, the functional units illustrated in FIG. 23 have functions similar to those of the functional units illustrated in FIG. 3, and perform processes similar to the processes illustrated in the sequence diagrams of FIGS. 4, 11, and 15 to 17. In FIG. 23, the functions of the information processing apparatus 10 in the above-described embodiments are implemented by the CPU of the communication terminal 20 executing instructions included in one or more programs installed in the communication terminal 20. One of the information processing apparatus 10 and the communication terminal 20 may not have all of the functions illustrated in FIG. 3 (or FIG. 23), and each of the information processing apparatus 10 and the communication terminal 20 may have some of the functions. In the case where each of the information processing apparatus 10 and the communication terminal 20 has some functions, the classification of the function group of the information processing apparatus 10 and the function group of the communication terminal 20 is not limited to a specific form. In the first to fifth embodiments, the substance of the program that functions as each agent is common among the agents. In another embodiment, however, the substance of the program may differ for each agent. For example, the substances of multiple programs, each of which functions as a different agent, may reside in the information processing apparatus 10 or the communication terminal 20. Further, each of the substances of the programs functioning as different agents may reside in different information processing apparatuses 10 (e.g., information processing apparatuses 10-1 and 10-2) as illustrated in FIG. 24. In this case, the communication terminal 20 may transmit a request to start interaction to the information processing apparatus 10 (e.g., the information processing apparatus 10-1) in which the substance of the program functioning as the general reception agent resides to start interaction with the general reception agent. Then, after an adopted agent is identified, the communication terminal 20 communicates with the other information processing apparatus 10 (e.g., the information processing apparatus 10-2) in which the adopted agent resides. Alternatively, the information processing apparatus 10 (e.g., the information processing apparatus 10-1) in which the general reception agent resides and the other information processing apparatus 10 (e.g., the information processing apparatus 10-2) in which the adopted agent resides may communicate with each other to implement interaction between the user and the adopted agent. Furthermore, the substance of the program functioning as the general reception agent may reside in the communication terminal 20. In this case, the general reception agent residing in the communication terminal 20 may communicate with each of one or more information processing apparatuses 10 in which different agents reside to implement interaction between the user and each of multiple agents.

The information processing apparatus 10 is not limited to a general-purpose server computer, and may be any apparatus having a communication function implemented by communication circuity. The information processing apparatus 10 may be, for example, an output device such as a projector (PJ), an interactive whiteboard (IWB; an electronic whiteboard having a blackboard function enabling mutual communication), or digital signage, or may be a head-up display (HUD), an industrial machine, an imaging device, a sound collecting device, a medical device, a networked home appliance, an automobile (connected car), a laptop personal computer (PC), a mobile phone, a smartphone, a tablet terminal, a game console, a personal digital assistant (PDA), a digital camera, a wearable PC, or a desktop PC.

Each of the functions described above in the embodiments of the present disclosure may be implemented by one processing circuit or a plurality of processing circuits. The “processing circuit or circuitry” herein includes a programmed processor to execute each function by software, such as a processor implemented by an electronic circuit, and devices, such as an application-specific integrated circuit (ASIC), a digital signal processor (DSP), a field-programmable gate array (FPGA), and circuit modules known in the art arranged to perform the recited functions.

The group of apparatuses or devices described in the above-described embodiments is merely one example of multiple computing environments for implementing the embodiments disclosed herein.

In some embodiments, the information processing apparatus 10 includes multiple computing devices, such as a server cluster. The multiple computing devices are configured to communicate with each other through any type of communication links, including a network or a shared memory, to perform the processes disclosed herein. Similarly, the communication terminal 20 may include multiple computing devices that are configured to communicate with each other.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Aspects of the present disclosure are, for example, as follows.

According to Aspect 1, an information processing system that functions as one or more interactive AIs that interact with a user, includes a reception unit that receives input of a first message from the user, an identification unit that identifies one or more specific interactive AIs to be caused to generate responses to the first message, based on the content of the first message, and a display control unit that controls to display the responses generated by the one or more specific interactive AIs in response to the first message and controls to display the one or more specific interactive AIs corresponding to the responses in a selectable manner, and when one interactive AI is designated from among the one or more specific interactive AIs displayed in the selectable manner, the display control unit controls to display a dialog screen for receiving input of a second message to the designated interactive AI.

According to Aspect 2, in the information processing system of Aspect 1, the identification unit refers to a database that stores a message previously received and information for identifying the interactive AI that has responded to the message in association with each other, and identifies the one or more specific interactive AIs to be caused to generate responses to the first message based on a relationship between the message previously received and the first message.

According to Aspect 3, in the information processing system of Aspect 2, the identification unit identifies the one or more specific interactive AIs to be caused to respond to the first message, based on a similarity, which is the relationship between the first message and each message stored in the database.

According to Aspect 4, in the information processing system of Aspect 2 or 3, the database further stores attribute information of the user who has input the message previously received, and the identification unit identifies the one or more specific interactive AIs to be caused to respond to the first message, based on a similarity between the attribute information of the user who has input the first message and the attribute information stored in the database.

According to Aspect 5, an information processing apparatus that functions as one or more interactive AIs that interact with a user, includes a reception unit that receives input of a first message from the user, an identification unit that identifies one or more specific interactive AIs to be caused to generate responses to the first message, based on the content of the first message, and a display control unit that controls to display the responses generated by the one or more specific interactive AIs in response to the first message and controls to display the one or more specific interactive AIs corresponding to the responses in a selectable manner, and when one interactive AI is designated from among the one or more specific interactive AIs displayed in the selectable manner, the display control unit controls to display a dialog screen for receiving input of a second message to the designated interactive AI.

According to Aspect 6, an information processing method performed by an information processing apparatus that functions as one or more interactive AIs that interact with a user, includes receiving input of a first message from the user, identifying one or more specific interactive AIs to be caused to generate responses to the first message, based on the content of the first message, controlling to display the responses generated by the one or more specific interactive AIs in response to the first message, controlling to display the one or more specific interactive AIs corresponding to the responses in a selectable manner, and when one interactive AI is designated from among the one or more specific interactive AIs displayed in the selectable manner, controlling to display a dialog screen for receiving input of a second message to the designated interactive AI.

According to Aspect 7, a non-transitory recording medium stores a plurality of program codes which, when executed by one or more processors on an information processing apparatus that functions as one or more interactive AIs that interact with a user, causes the one or more processors to perform a method including receiving input of a first message from the user, identifying one or more specific interactive AIs to be caused to generate responses to the first message, based on the content of the first message, controlling to display the responses generated by the one or more specific interactive AIs in response to the first message, controlling to display the one or more specific interactive AIs corresponding to the responses in a selectable manner, and when one interactive AI is designated from among the one or more specific interactive AIs displayed in the selectable manner, controlling to display a dialog screen for receiving input of a second message to the designated interactive AI.

According to Aspect 8, an information processing system that functions as one or more interactive AIs that interact with a user, includes a reception unit that receives input of a first message from the user, an identification unit that identifies one or more specific interactive AIs to be caused to generate responses to the first message, based on the content of the first message, and a display control unit that controls to display the responses generated by the one or more specific interactive AIs in response to the first message and controls to display the one or more specific interactive AIs corresponding to the responses in a selectable manner, and when one interactive AI is designated from among the one or more specific interactive AIs displayed in the selectable manner, the display control unit controls to display a dialog screen for receiving input of a second message to the designated interactive AI. The information processing system transmits, to a communication terminal, web content data for displaying a first web page and a second web page, the first web page presenting a screen for receiving the input of the first message from the user, and the second web page presenting the responses and presenting the one or more specific interactive AIs corresponding to the responses in the selectable manner. The web content data includes a script for executing at least a process for transmitting the first message input on the first web page to the communication terminal and a process for displaying the second web page on which the one or more specific interactive AIs are presented. When the reception unit receives a HyperText Transfer Protocol (HTTP) request, which is transmitted by executing the script on the communication terminal and includes the first message input on the first web page displayed on the communication terminal based on the web content data, the identification unit identifies the one or more specific interactive AIs to be caused to generate responses to the first message, based on the content of the first message. The display control unit transmits, as a response to the HTTP request, an HTTP response including information indicating the identified one or more specific interactive AIs to the communication terminal to cause the communication terminal to execute the script and display the second web page.

According to Aspect 9, a communication terminal that functions as one or more interactive AIs that interact with a user, includes a reception unit that receives input of a first message from the user, an identification unit that identifies one or more specific interactive AIs to be caused to generate responses to the first message, based on the content of the first message, and a display control unit that controls to display the responses generated by the one or more specific interactive AIs in response to the first message and controls to display the one or more specific interactive AIs corresponding to the responses in a selectable manner, and when one interactive AI is designated from among the one or more specific interactive AIs displayed in the selectable manner, the display control unit controls to display a dialog screen for receiving input of a second message to the designated interactive AI.

According to Aspect 10, an information processing system includes an information processing apparatus that functions as one or more interactive AIs that interact with a user and a communication terminal. The information processing apparatus includes a reception unit that receives input of a first message from the user, an identification unit that identifies one or more specific interactive AIs to be caused to generate responses to the first message, based on the content of the first message, and a display control unit that controls to display the responses generated by the one or more specific interactive AIs in response to the first message and controls to display the one or more specific interactive AIs corresponding to the responses in a selectable manner, and when one interactive AI is designated from among the one or more specific interactive AIs displayed in the selectable manner, the display control unit controls to display a dialog screen for receiving input of a second message to the designated interactive AI. The communication terminal includes a reception unit that receives input of the first message and a display control unit that controls to display the one or more specific interactive AIs, which correspond to the responses generated by the one or more specific interactive AIs in response to the first message, in a selectable manner. When one interactive AI is designated from among the one or more specific interactive AIs displayed in the selectable manner, the display control unit controls to display a dialog screen for receiving input of a second message to the designated interactive AI.

According to Aspect 11, a communication terminal that functions as a first interactive AI that interacts with a user, includes a reception unit that receives input of a first message from the user, an identification unit that identifies one or more second interactive AIs to be caused to generate responses to the first message based on the content of the first message, each second interactive AI residing in one of one or more information processing apparatuses, and a display control unit that controls to display the responses generated by the one or more second interactive AIs identified by the identification unit in response to the first message and controls to display the one or more second interactive AIs corresponding to the responses in a selectable manner. When one interactive AI is designated from among the one or more second interactive AIs displayed in the selectable manner, the display control unit controls to display a dialog screen for receiving input of a second message to the designated interactive AI.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

In another aspect, an information processing system includes circuitry to receive input of a first message from a user, identify one or more specific interactive AIs to be caused to generate responses to the first message, based on a content of the first message, display, on a display, the responses generated by the one or more specific interactive AIs in response to the first message, display, on the display, the one or more specific interactive AIs corresponding to the responses in a selectable manner, and in a case that an interactive AI is designated from among the one or more specific interactive AIs displayed in the selectable manner, display, on the display, a dialog screen for receiving input of a second message to the interactive AI.

In another aspect, an information processing apparatus includes circuitry to receive input of a first message from a user, identify one or more specific interactive AIs to be caused to generate responses to the first message, based on a content of the first message, display, on a display, the responses generated by the one or more specific interactive AIs in response to the first message, display, on the display, the one or more specific interactive AIs corresponding to the responses in a selectable manner, and in a case that an interactive AI is designated from among the one or more specific interactive AIs displayed in the selectable manner, display, on the display, a dialog screen for receiving input of a second message to the interactive AI.

In another aspect, a communication terminal includes circuitry to receive input of a first message from a user, identify one or more specific interactive AIs to be caused to generate responses to the first message, based on a content of the first message, display, on a display, the responses generated by the one or more specific interactive AIs in response to the first message, display, on the display, the one or more specific interactive AIs corresponding to the responses in a selectable manner, and in a case that an interactive AI is designated from among the one or more specific interactive AIs displayed in the selectable manner, display, on the display, a dialog screen for receiving input of a second message to the interactive AI.

In another aspect, an information processing system includes an information processing apparatus and a communication terminal. The information processing apparatus includes first circuitry to receive input of a first message from a user, identify one or more specific interactive AIs to be caused to generate responses to the first message, based on a content of the first message, display, on a display, the responses generated by the one or more specific interactive AIs in response to the first message, display, on the display, the one or more specific interactive AIs corresponding to the responses in a selectable manner, and in a case that an interactive AI is designated from among the one or more specific interactive AIs displayed in the selectable manner, display, on the display, a dialog screen for receiving input of a second message to the interactive AI. The communication terminal includes second circuitry to receive input of the first message, display, on another display, the one or more specific interactive AIs corresponding to the responses generated by the one or more specific interactive AIs in response to the first message in the selectable manner, and in the case that the interactive AI is designated from among the one or more specific interactive AIs displayed in the selectable manner, display, on the other display, the dialog screen for receiving the input of the second message to the designated interactive AI.

In another aspect, a communication terminal includes circuitry to receive input of a first message from a user, identify one or more second interactive AIs to be caused to generate responses to the first message based on a content of the first message, each second interactive AI residing in one of one or more information processing apparatuses, display, on a display, the responses generated by the identified one or more second interactive AIs in response to the first message, display, on the display, the one or more second interactive AIs corresponding to the responses in a selectable manner, and in a case that an interactive AI is designated from among the one or more second interactive AIs displayed in the selectable manner, display, on the display a dialog screen for receiving input of a second message to the designated interactive AI.

1. An information processing system comprising:
an information processing apparatus including first circuitry; and
a communication terminal including second circuitry,
the first circuitry being configured to:
transmit, to the communication terminal, web content data for displaying a first web page and a second web page and including a script, the second circuitry being configured to:
display, on a display, the first web page based on the web content data;
receive an input of a first message from a user via the first web page; and
execute the script to transmit a HyperText Transfer Protocol (HTTP) request including the first message to the information processing apparatus, the first circuitry being configured to:
in response to the HTTP request, identify a plurality of interactive artificial intelligences (AIs) based on the first message, each AI being configured to generate a response to the first message; and
transmit an HTTP response including information on the plurality of interactive AIs to the communication terminal, the second circuitry being configured to:
execute the script to display, on the display, the second web page including the responses to the first message from the plurality of interactive AIs based on the HTTP response to allow the user to select one or more of the plurality of interactive AIs; and
in a case that one interactive AI is selected from among the plurality of interactive AIs, display, on the display, a dialog screen for receiving input of a second message to the selected interactive AI.

2. The information processing system according to claim 1, further comprising a memory that stores a plurality of messages previously received and information for identifying the interactive AI that has responded to each message in association, and
the first circuitry is configured to identify each of the plurality of interactive AIs based on a relationship between each of the messages previously received and the first message.

3. The information processing system according to claim 2, wherein
the relationship is a similarity between each of the messages stored in the memory and the first message.

4. The information processing system according to claim 2, wherein
the memory further stores attribute information of the user who has input a message previously received, and
the first circuitry is configured to identify the plurality of specific interactive AIs based on a similarity between the attribute information of the user who has input the first message and the attribute information stored in the memory.

5. An information processing method performed by an information processing apparatus communicably connected with a communication terminal, the method comprising:
transmitting, to the communication terminal, web content data for displaying a first web page and a second web page and including a script;
receiving a HyperText Transfer Protocol (HTTP) request transmitted from the communication terminal in execution of the script, the HTTP request including a first message being input by a user on the first web page displayed on the communication terminal based on the web content data;
identify a plurality of interactive artificial intelligences (AIs) based on the first message, each AI being configured to generate a response to the first message;
transmit an HTTP response including information on the plurality of interactive AIs to the communication terminal,
the script further causing the communication terminal to display the second web page including the responses to the first message from the plurality of interactive AIs based on the HTTP response to allow the user to select one or more of the plurality of interactive AIs; and
in a case that one interactive AI is selected from among the plurality of interactive AIs, causing the communication terminal to display a dialog screen for receiving input of a second message to the selected interactive AI.

6. A non-transitory recording medium storing a plurality of program codes which, when executed by one or more processors on an information processing, causes the one or more processors to perform a method, the method comprising:
transmitting, to the communication terminal, web content data for displaying a first web page and a second web page and including a script;
receiving a HyperText Transfer Protocol (HTTP) request transmitted from the communication terminal in execution of the script, the HTTP request including a first message being input by a user on the first web page displayed on the communication terminal based on the web content data;
identify a plurality of interactive artificial intelligences (AIs) based on the first message, each AI being configured to generate a response to the first message;
transmit an HTTP response including information on the plurality of interactive AIs to the communication terminal,
the script further causing the communication terminal to display the second web page including the responses to the first message from the plurality of interactive AIs based on the HTTP response to allow the user to select one or more of the plurality of interactive AIs; and
in a case that one interactive AI is selected from among the plurality of interactive AIs, causing the communication terminal to display a dialog screen for receiving input of a second message to the selected interactive AI.
